(19) United States
(12) Patent Application Publication
(10) Pub. No.: US 2018/0376380 A1
(43) Pub. Date: Dec. 27, 2018

(54) EXPOSURE OF CAPABILITIES OF CENTRAL UNITS AND DISTRIBUTED UNITS IN BASE STATION ENTITIES FOR ADMISSION CONTROL

(71) Applicant: Philippe LEROUX, Ottawa (CA)

(72) Inventor: Philippe LEROUX, Ottawa (CA)

(73) Assignee: Huawei Technologies Co., Ltd., Shenzhen (CN)

(21) Appl. No.: 15/997,827

(22) Filed: Jun. 5, 2018

Related U.S. Application Data
(60) Provisional application No. 62/524,175, filed on Jun. 23, 2017.
(60) Provisional application No. 62/524,144, filed on Jun. 23, 2017.

(51) Int. Cl. H04W 36/00; H04W 36/08; H04W 76/27; H04L 12/891; H04W 4/70

(52) U.S. Cl. CPC H04W 36/0011; H04W 36/08; H04W 84/042; H04L 47/41; H04W 4/70; H04W 76/27

(57) ABSTRACT

Methods for configuring a radio transceiver comprising a CU coupled to DU comprise the DU receiving a connection request from a UE, forwarding it to the CU, providing the CU with information so that the CU can determine whether the DU will support the request, the CU determining whether it will support the request and if both are so prepared, cooperating to couple the UE with the DU and CU. The DU can decide whether it will support the request and communicate it to the CU and if not, can transmit the request to another DU and so advise the CU. Alternatively the DU can expose its capabilities to the CU and allow the CU to decide whether the DU will support the request and communicate it to the DU.

### CROSS-REFERENCE TO RELATED APPLICATIONS

This application claims benefit of U.S. Provisional Patent Application No. 62/524,175 entitled “Exposure of Capabilities of Central Units and Distributed Units in Base Station Entities” filed 23 Jun. 2017 and U.S. Provisional Patent Application No. 62/524,144 entitled “Admission Control Function in a CU-DU Split gNB” filed 23 Jun. 2017, the contents of which are incorporated herein by reference, inclusive of all filed references.

### TECHNICAL FIELD

The present disclosure relates to the fields of communication networks and mobile communications and particular embodiments or aspects relate to admission control (AC) function and to methods and apparatus for configuring a wireless network base station entity comprised of at least one central unit (CU) and at least one distributed unit (DU) coupled by a communication link.

### BACKGROUND

In wireless communication networks, electronic devices (EDs) or user equipment (UEs) communicate with a core network (CN) through one or more base stations (BS), such as, in the context of 3GPP long-term evolution (LTE), evolved NodeBs (eNodeBs or eNBs) along a wireless LTE-Uu or Uu interface.

In next generation (NG), including without limitation, 5^{th} Generation (5G), wireless systems, the concept of a base station entity has evolved from a single physical node such as an eNB, to a virtual concept comprising a plurality of nodes or sub-nodes, collectively referred to as a next generation NodeB (sometimes referred to as a gNodeB or gNB).

The Third Generation Partnership Project (3GPP) has defined standards that support splitting the functionality of gNB between a CU and one or more DUs. However, these standards do not provide cost effective methods for handling AC, which supports practical implementation of a CU-DU split gNB.

As shown in FIG. 3 which is a simplified model, the gNB architecture 300 is split into two parts, comprising at least one central unit (CU) 310 (sub-)node coupled to at least one distributed unit (DU) 320 (two are shown) (sub-)node by a communications link 315. In some examples, the link 315 comprises at least one of an F1 interface (discussed in 3GPP standard 38.474 F1 data transport) or a corresponding F1-AP (application protocol) interface (discussed in 3GPP standard 38.473 F1-AP) (collectively “F1”) link. One or more UEs 352 is coupled to and communicates wirelessly with a cell (not shown) of a DU 320 along a Uu interface link 325.

The core network (CN) 330 is coupled to and communicates with a CU 310 along a NG interface link 335 (described in 3GPP standard 38.401 NG Architecture description). In some examples, the CN 330 can be an Evolved Packet Core (EPC) network on an NG core network as can be defined in 3GPP technical specification TS 23.501. In some examples, the CU 310 is provided with an internet address by which the CU 310 can be either accessed by the CN 330 or access the CN 330. In some examples, the CU 310 is a core entity that defines the gNB 300. In such cases, such internet address is associated with the gNB 300.

In FIG. 4, a plurality of gNBs 300, designated A and B in an NG (radio) access network (RAN or (R)AN) 400, is shown, coupled by an Xn interface link 415. As shown by way of non-limiting example, gNB A 300 comprises a single CU 310 coupled to two DUs 320, respectively designated A and B, by F1 interface links 315, and gNB B 300 comprises a single (different) CU 310 coupled to two DUs 320 by F1 interface links 315. The two DUs 320 are respectively DU B 320 and a third DU 320, designated C. Thus, both gNB A 300 and gNB B 300 have a common DU B 320 associated therewith and in that sense may be considered to be overlapping. In the figure, the CN 330 is coupled to each CU 310 by an NG interface link 335 and the UE 352 is coupled to a cell of the common DU B 320 by a Uu interface link 325. Thus, it may be considered that different gNBs 300 would support the same cells from the same DUs 320.

In FIG. 5, a plurality of gNBs 300, respectively designated A and B in NG-RAN 400, is shown. Here, however, gNB A 300 and gNB B 300 do not overlap in that they do not have a common DU 320. Rather, gNB A 300 comprises a CU 310, designated A, coupled to two DUs 320, respectively designated A and B, by F1 interface links 315. gNB A 300 is coupled to CN 330 by an NG interface link 335 and UE 352 is coupled to a cell of DU B 320 by a Uu interface link 325.

gNB B 300 comprises a CU 310, designated B, coupled to two DUs 320, respectively designated C and D, by respective F1 interface links 315. gNB B 300 is coupled to CN 330 by an NG interface link 335.

The gNBs 300 are coupled by Xn interface link 415.

The details of the gNB 300 concept are still evolving. By way of non-limiting example, it is conceivable that a gNB 300 may comprise a plurality of CUs 310. If so, it may no longer be appropriate to assume that the CU 310 is a core entity that defines the gNB 300.

Similarly, the details of the Xn interface 415 are not presently finalized beyond identification that it is an interface between two gNBs 300. It is conceivable that such interface will couple CUs 310 as the core of the gNB 300 (as shown, by way of non-limiting example), or that the DUs 320 will take responsibility for such interface 415, or some mixed responsibility.

Still further, the allocation of responsibility as between a CU 310 and a DU 320 within a gNB 300 is not yet finalized. Currently, it is foreseen that most radio resource control (RRC) functions, including without limitation, user-related functions, would be allocated to the CU 310 and most radio resource management (RRM) functions, including without limitation, cell management functions, would be allocated to the DU 320.

Furthermore, the allocation of functionality between CUs 310 and DUs 320 may impact different demands for each of the CU 310 and the DU 320 to expose its capabilities to entities coupled thereto, including each other. Put another way, the decision of allocation of functionality as between CUs 310 and DUs 320 may be impacted by consideration of what capabilities could be exposed by either or both of the CU 310 and DU 320 and the complexity involved for such nodes to expose such capabilities.

Accordingly, there may be a need for a system and method for Admission Control function in a CU-DU split gNB and for exposure of capabilities in support thereof that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE DRAWINGS

Further features of example embodiments of the present disclosure will become apparent from the following detailed description, taken in combination with the following figures, in which identical reference numerals in different figures indicate identical elements and in which:

FIG. 1 is a block diagram of an electronic device within a computing and communications environment 50 that may be used for implementing devices and methods in accordance with representative examples of the present disclosure;

FIG. 2 is a block diagram illustrating an architecture of a 5G Radio Access network architecture;

FIG. 3 is a block diagram showing an example CU-DU split gNB architecture, comprising at least one CU coupled to at least one DU, in communication with a UE and a CN according to an example;

FIG. 4 is a block diagram showing an example CU-DU split gNB architecture comprising a plurality of gNBs in communication with the UE and the CN, where each gNB comprises a common DU according to an example;

FIG. 5 is a block diagram showing an example CU-DU split gNB architecture comprising a plurality of coupled gNBs in communication with the UE and the CN, where each gNB comprise different DUs according to an example;

FIG. 6 is a block diagram illustrating a Protocol Stack model usable in the architectures of FIGS. 3-5;

FIG. 7 is a message flow diagram illustrating a set of three scenarios for admission control according to an example;

FIG. 8 is a message flow diagram illustrating an example Admission Control process including CU handover according to an example;

FIG. 9 is a message flow diagram illustrating an example Admission Control process including DU handover according to an example;

FIG. 10 is a flow chart showing method actions according to an example;

FIG. 11 is a flow chart showing method actions according to an example;

FIG. 12 is a flow chart showing method actions according to an example;

FIG. 13 is a flow chart showing method actions according to an example; and

FIG. 14 is a block diagram of a processing system according to an example.

For purposes of explanation and not limitation, specific details are set forth in order to provide a thorough understanding. In some instances, detailed descriptions of well-known devices, circuits and methods are omitted so as not to obscure the description with unnecessary detail.

Accordingly, the system and method components have been represented where appropriate by conventional symbols in the drawings, showing only those specific details that are pertinent to understanding the examples of the present disclosure, so as not to obscure the disclosure with details that will be readily apparent to those of ordinary skill in the art having the benefit of the description herein.

Any feature or action shown in dashed outline may in some example examples be considered as optional.

### SUMMARY

It is an object of the present disclosure to obviate or mitigate at least one disadvantage of the prior art.

According to a first broad aspect of the present disclosure, there is disclosed a method for configuring a radio transceiver comprising at least one CU and at least one DU coupled thereto in a wireless communication system comprising actions, at the at least one DU, of receiving a connection request from a UE; forwarding the connection request to the at least one CU; providing the at least one CU with information that permits the at least one CU to determine whether the at least one DU will support the connection request; receiving a determination from the at least one CU as to whether the at least one CU will support the connection request; and if the at least one CU and the at least one DU will support the connection request, effecting coupling of the UE with the at least one DU and the at least one CU in cooperation with the at least one CU.

In an embodiment, the action of providing can comprise coordinating with a MP entity to identify resources accessible by the at least one DU to support the connection request.

In an embodiment, the action of providing can comprise actions of making a DU decision as to whether the at least one DU will support the connection request and communicating the DU decision to the at least one CU. In an embodiment, the action of providing can comprise, if the DU decision is not to support the communication request, transmitting the connection request to a further one of the at least one DUs to make a DU decision for communication to the at least one CU and advising the at least one CU that the connection request has been forwarded to the further one of the at least one DUs. In an embodiment, the action of providing can comprise actions of exposing capabilities of the at least one DU to that at least one CU to allow the at least one CU to make a decision as to whether the at least one DU will support the connection request, and communicating the decision to the at least one DU. In an embodiment, the action of exposing can occur in advance of the action of receiving the connection request. In an embodiment, the action of exposing can occur periodically.

In an embodiment, the action of receiving can comprise the at least one CU coordinating with an MP entity to identify resources accessible by the at least one CU to support the connection request.

In an embodiment, the action of effecting coupling can comprise informing the at least one CU to arrange for traffic intended for the UE to be routed through the at least one DU.

According to a second broad aspect of the present disclosure, there is disclosed a method for configuring a radio transceiver comprising at least one CU and at least one DU coupled thereto in a wireless communication system comprising actions, at the at least one CU, of: receiving a connection request of a UE from the at least one DU after the at least one DU has received it from the UE; obtaining information from the at least one DU that permits the at least one CU to determine whether the at least one DU will support the connection request; arriving at a CU determination whether the at least one CU will support the connection request and communicating the CU determination to the at least one DU; and if the at least one CU and the at least one DU will support the connection request, effecting coupling of the UE with the at least one DU and the at least one CU in cooperation with the at least one DU.

In an embodiment, the action of obtaining can comprise the at least one DU coordinating with a MP entity to identify resources accessible by the at least one DU to support the connection request.

In an embodiment, the action of obtaining can comprise learning a DU decision from the at least one DU as to whether the at least one DU will support the connection request. In an embodiment, the action of obtaining can comprise, if the DU decision is not to support the communication request, receiving advice that the at least one DU has communicated the connection request to a further one of the at least one DUs. In an embodiment, the action of obtaining can comprise actions of receiving capabilities of the at least one DU exposed by the at least one DU to allow the at least one CU to make a DU determination as to whether the at least one DU will support the connection request, and communicating the DU determination to the at least one DU. In an embodiment, the action of receiving capabilities can occur in advance of the action of receiving the connection request. In an embodiment, the action of receiving capabilities can occur periodically.

In an embodiment, the action of arriving can comprise coordinating with a MP entity to identify resources accessible by the at least one CU to support the connection request.

In an embodiment, the action of effecting coupling can comprise arranging for traffic intended for the UE to be routed through the at least one DU.

According to a third broad aspect of the present disclosure, there is disclosed a DU coupled to at least one CU in a radio transceiver of a wireless communication system. The DU has a processor and a non-transitory memory. The memory contains instructions that, when executed by the processor, causes the DU to perform actions of: receiving a connection request from a UE; forwarding the connection request to the at least one CU; providing the at least one CU with information that permits the at least one CU to determine whether the DU will support the connection request; receiving a determination from the at least one CU as to whether the at least one CU will support the connection request; and if the at least one CU and the DU will support the connection request, effecting coupling of the UE with the DU and the at least one CU in cooperation with the at least one CU.

According to a fourth broad aspect of the present disclosure, there is disclosed a CU coupled to at least one DU in a radio transceiver of a wireless communication system. The CU has a processor and a non-transitory memory. The memory contains instructions that, when executed by the processor, causes the CU to perform actions of: receiving a connection request of a UE from the at least one DU after the at least one DU has received it from the UE; obtaining information from the at least one DU that permits the CU to determine whether the at least one DU will support the connection request; arriving at a CU determination whether the CU will support the connection request and communicating the CU determination to the at least one DU; and if the CU and the at least one DU will support the connection request, effecting coupling of the UE with the at least one DU and the CU in cooperation with the at least one DU.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Some aspects and embodiments of the present disclosure may provide a method and apparatus for exposure of capabilities of CUs and DUs in BS entities for AC.

### DESCRIPTION

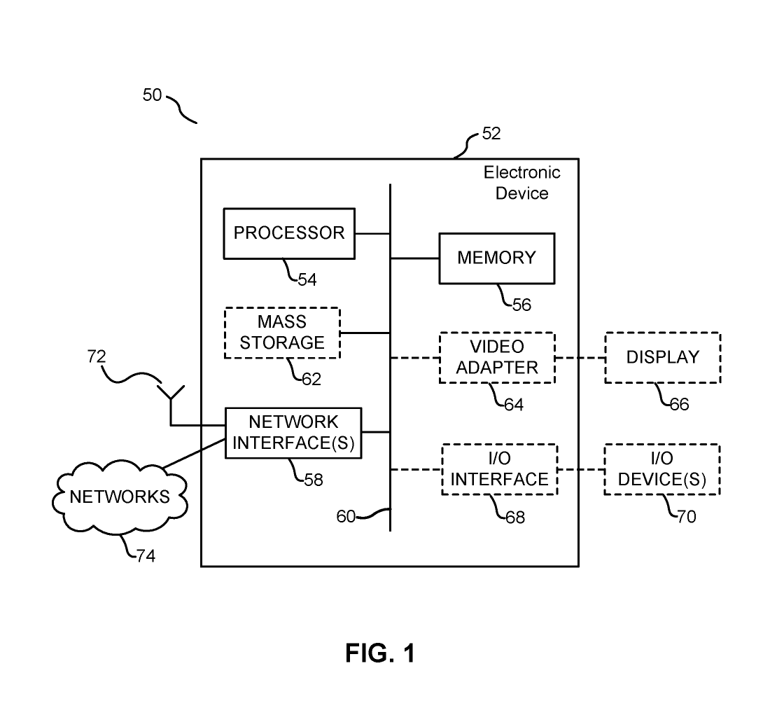

FIG. 1 is a block diagram of an ED 52 illustrated within a computing and communications environment 50 that may be used for implementing the devices and methods disclosed herein. In some examples, the ED 52 may be an element of communications network infrastructure, such as a base station (for example a NodeB, an eNB, a gNB 300, a home subscriber server (HSS), a gateway (GVV) such as a packet gateway (PGVV) or a serving gateway (SGVV) or various other nodes or functions within a CN 330 or Public Land Mobility Network (PLMN). In other examples, the ED 52 may be a device that couples to the network infrastructure over a radio interface, such as a mobile phone, smart phone or other such device that may be classified as a UE 352. In some examples, the ED 52 may be a Machine Type Communications (MTC) device (also referred to as a machine-to-machine (m2m) device), or another such device that may be categorized as a UE 352 despite not providing a direct service to a user. In some references, an ED 52 may also be referred to as a mobile device, a term intended to reflect devices that couple to a mobile network, regardless of whether the device itself is designed for, or capable of, mobility. Specific devices may utilize all of the components shown or only a subset of the components, and levels of integration may vary from device to device. Furthermore, a device may contain multiple instances of a component, such as multiple processors, memories, transmitters, receivers, etc. The ED 52 typically includes a processor 54, such as a Central Processing Unit (CPU) and may further include specialized processors such as a Graphics Processing Unit (GPU) or other such processor, a memory 56, a network interface 58 and a bus 60 to couple the components of ED 52. ED 52 may optionally also include components such as a mass storage device 62, a video adapter 64, and an I/O interface 68 (shown in dashed outline).

The memory 56 may comprise any type of non-transitory system memory, readable by the processor 54, such as static random access memory (SRAM), dynamic random access memory (DRAM), synchronous DRAM (SDRAM), read-only memory (ROM), or a combination thereof. In an example, the memory 56 may include more than one type of memory, such as ROM for use at boot-up, and DRAM for program and data storage for use while executing programs. The bus 60 may be one or more of any type of several bus architectures including a memory bus or memory controller, a peripheral bus, or a video bus.

The ED 52 may also include one or more network interfaces 58, which may include at least one of a wired network interface and a wireless network interface. As illustrated in FIG. 1, a network interface 58 may include a wired network interface to couple to a network 74, and also may include a radio access network interface 72 for coupling to other devices over a radio link. When ED 52 is a network infrastructure element, the radio access network interface 72 may be omitted for nodes or functions acting as elements of the PLMN other than those at the radio edge (e.g. an eNB). When ED 52 is infrastructure at the radio edge of a network 74, both wired and wireless network interfaces may be included. When ED 52 is a wirelessly coupled device, such as a UE, radio access network interface 72 may be present and it may be supplemented by other wireless interfaces such as WiFi network interfaces. The network interfaces 58 allow the ED 52 to communicate with remote entities such as those coupled to network 74.

The mass storage 62 may comprise any type of non-transitory storage device configured to store data, programs and other information and to make the data, programs and other information accessible via the bus 60. The mass storage 62 may comprise, for example, one or more of a solid-state drive, hard disk drive, a magnetic disk drive or an optical disk drive. In some examples, mass storage 62 may be remote to ED 52 and accessible through use of a network interface such as interface 58. In the illustrated example, mass storage 62 is distinct from memory 56 where it is included, and may generally perform storage tasks compatible with higher latency, but may generally provide lesser or no volatility. In some examples, mass storage 62 may be integrated with a heterogeneous memory 56.

The optional video adapter 64 and the I/O interface 68 (shown in dashed outline) provide interface to couple the ED 52 to external input and output devices. Examples of input and output devices include a display 66 coupled to the video adapter 64 and an I/O device 70 such as a touch-screen coupled to the I/O interface 68. Other devices may be coupled to the ED 52, and additional or fewer interfaces may be utilized. For example, a serial interface such as a Universal Serial Bus (USB) (not shown) may be used to provide an interface for an external device. Those skilled in the art will appreciate that in examples in which ED 52 is part of a data center, I/O interface 68 and Video Adapter 64 may be virtualized and provided through network interface 58.

In some examples, ED 52 may be a stand-alone device, while in other examples ED 52 may be resident within a data center. A data center, as will be understood in the art, is a collection of computing resources (typically in the form of services) that can be used as a collective computing and storage resource. Within a data center, a plurality of services can be coupled together to provide a computing resource pool upon which virtualized entities can be instantiated. Data centers can be coupled with each other to form networks consisting of pooled computing and storage resources coupled to each other by connectivity resources. The connectivity resources may take the form of physical connections such as Ethernet or optical communications links, and in some instances may include wireless communication channels as well. If two different data centers are coupled by a plurality of different communication channels, the links can be combined together using any of a number of techniques including the formation of link aggregation groups (LAGs). It should be understood that any or all of the computing, storage and connectivity resources (along with other resources within the network 74) can be divided between different sub-networks, in some cases in the form of a resource slice. If the resources across a number of coupled data centers or other collection of nodes are sliced, different network slices can be created.

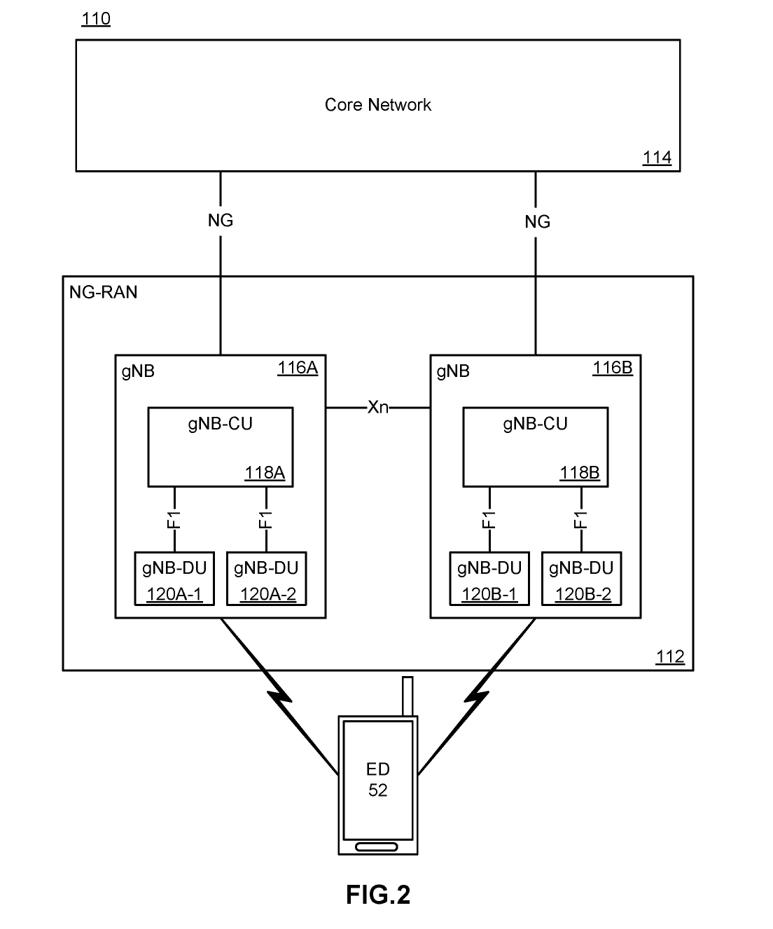

FIG. 2 illustrates a proposed architecture 110 for the implementation of a NG-RAN 112, also referred to as a 5G RAN. NG-RAN 112 is the radio access network that couples an ED 52 to a CN 114. Those skilled in the art will appreciate that CN 114 may be a 5^{th} Generation CN (5GCN). In other examples, the CN 114 may be a 4G EPC network. Nodes within NG-RAN 112 couple to the 5G CN 114 over an NG bearer or interface. This NG bearer interface can comprise both the NG-C(N2) interface to a CP 108 and an NG-U (N3) interface to a user plane (UP) function (UPF) 86. The N3 interface can provide a connection to a CN UPF. NG-RAN 112 includes a plurality of radio access nodes (referred to in an SA2 architecture either as a (radio) access node, or as a node within a (radio access network) that can be referred to as a gNB. In 3G, the access node was referred to as a NodeB (NB), while in 4G it was referred to as an eNB. In a NodeB, coordination with a Radio Node Controller (RNC) was employed to perform the radio resource and some of the mobility management functions for the Node B. With the development of the eNB, both scheduling and radio resource management were moved to the eNB. In the NG-RAN 112, a gNB 116A and gNB 116B are able to communicate with each other over an Xn interface. Within a single gNB 116A, the functionality of the gNB may be decomposed into a Centralized Unit (gNB-CU) 118A and a set of distributed units (gNB-DU 120A-1 and gNB-DU 120A-2, collectively referred to as 120A). gNB-CU 118A is coupled to a gNB-DU 120A over an F1 interface. Similarly gNB 116B has a gNB-CU 118B connecting to a set of distributed units gNB-DU 120B-1 and gNB-DU 120B-2, collectively referred to as 120B). Each gNB DU may be responsible for one or more cells providing radio coverage within the PLMN.

A RAN node is also coupled to user equipment (UE—such as, for example Electronic Device) 52 via a radio link (Uu) and to other RAN nodes via an Xn interface that includes both a control plane component (Xn-C) and a user plane component (Xn-U).

A UE may establish multiple protocol data unit (PDU) sessions with the CN where different sessions may correspond to different instances of the NG-U user plane interface; each instance of the NG-U interface may terminate on a different CN user plane entity.

In an LTE system, similar interfaces exist: a RAN node is coupled to a CN through an S1 interface and to other RAN nodes through an X2 interface.

The division of responsibilities between the gNB-CU and the gNB-DU has not been fully defined at this time. Different functions, such as the radio resource management functionality may be placed in one of the CU and the DU. As with all functional placements, there may be advantages and disadvantages to placement of a particular NF in one or the other location. It should also be understood that any or all of the functions discussed above with respect to the NG-RAN 112 may be virtualized within a network, and the network itself may be provided as network slice of a larger resource pool, as will be discussed below.

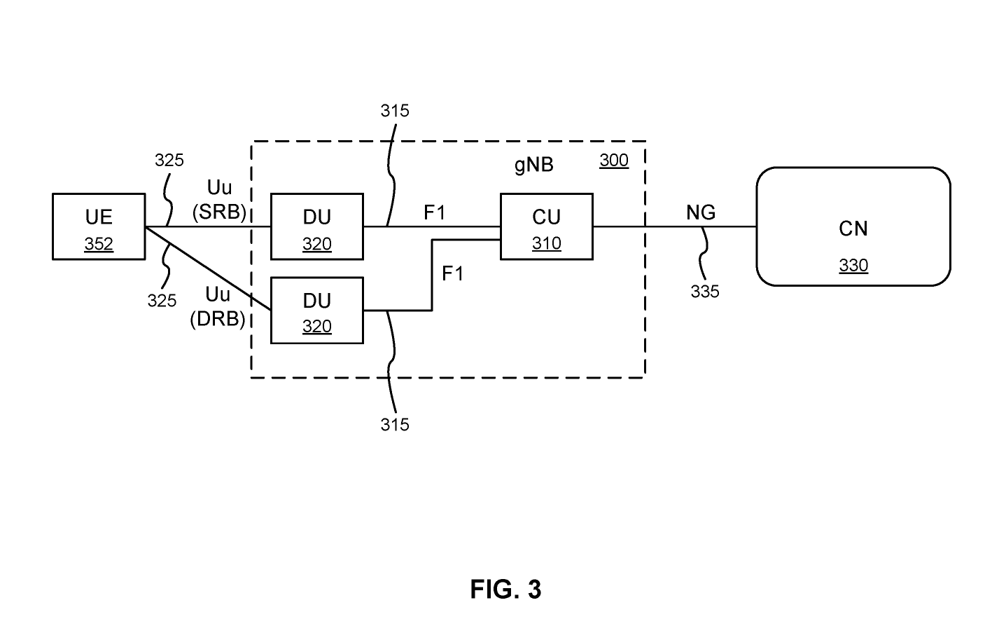

In the example illustrated in FIG. 3, the UE 352 is coupled to one DU for both signalling radio bearer (SRB) and data radio bearer (DRB) traffic. As a variant, the UE 352 may be coupled to one DU 320 for DRB traffic, and either the other DU 320 or the CU 310 for SRB traffic. The model of FIG. 3 enables handover of the UE 352 from one DU 320 to the other DU 320. In this case, the new DU 320 executes an AC process to accept or refuse the connection to the UE 352, based on the availability of its own resources. If the new DU 320 accepts the coupling to the UE 352, it can inform the CU 310, which may then reroute traffic destined to the UE 352 through the new DU 320.

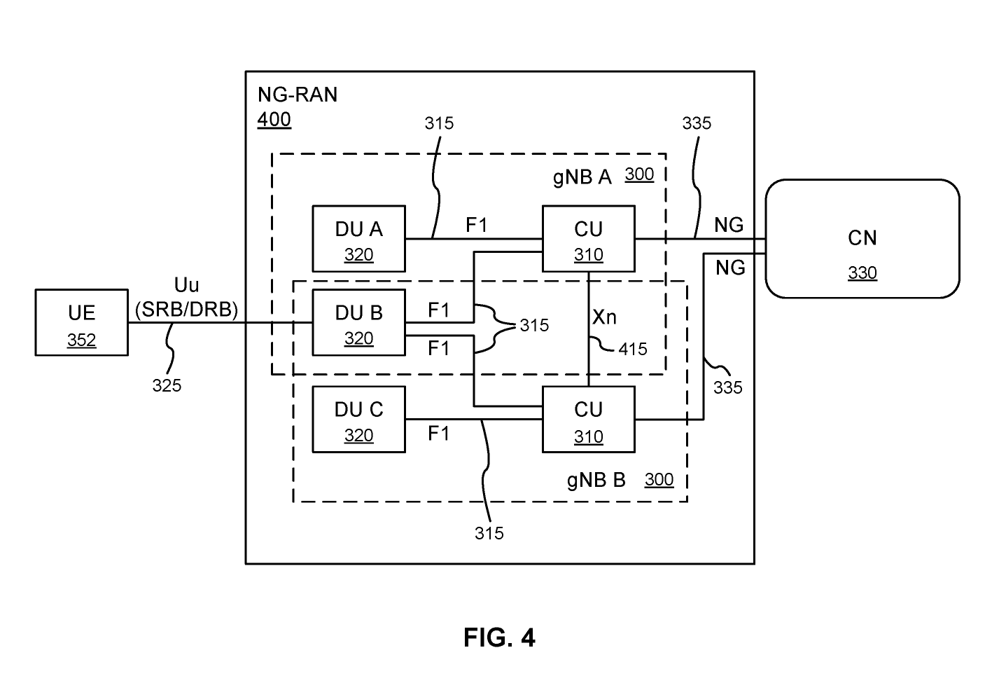

In the model illustrated in FIG. 4, the two CUs 310 may coordinate traffic flows and load sharing via the Xn interface 415. In addition, the common DU 320 may select either one of its two coupled CUs 310 for a given coupling, for example based on information of available resources in each CU 310.

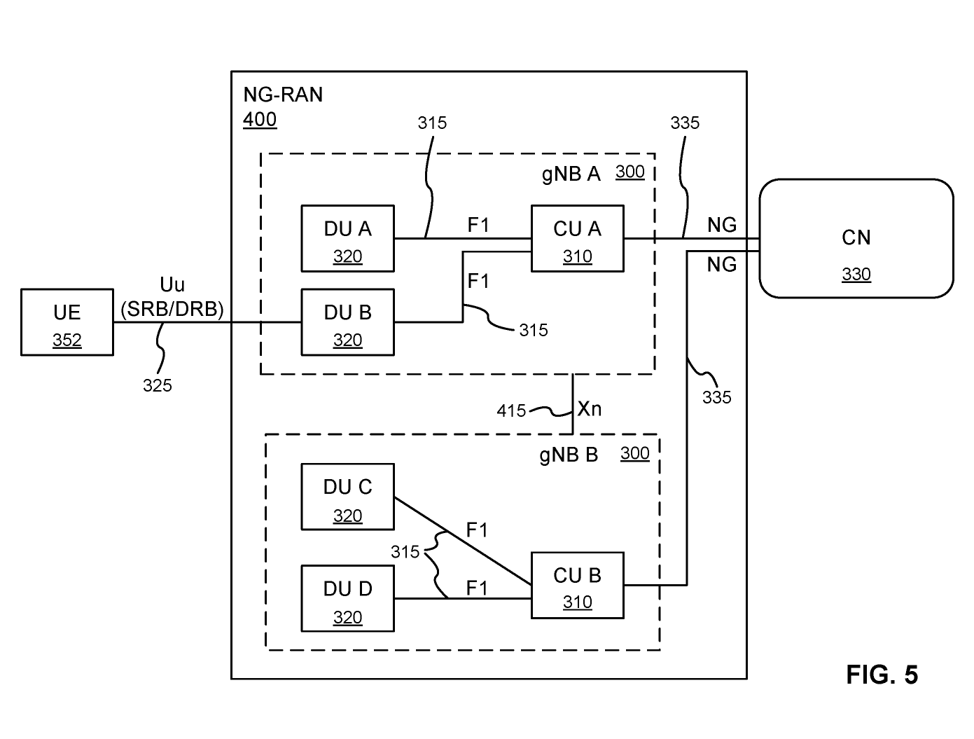

In the example illustrated in FIG. 5, the UE 352 is coupled to DU B 320 for both SRB and DRB traffic. The UE 352 may be, as a variant, instead coupled to one DU 320 for DRB traffic, and another DU 320 (either within the same or a different gNB 300) for SRB traffic. The model of FIG. 5 enables handover of the UE 352 from one DU 320 to another DU 320. However, in this case, there are two different handover scenarios.

In a first scenario, the source and target (new) DUs 320 are part of the same gNB 300, similar to that of FIG. 3. In this case, the new DU 320 executes an AC process to accept or refuse the coupling to the UE 352, based on the availability of its own resources. If the new DU 320 accepts the coupling to the UE 352, it can inform the CU 310, which may then reroute traffic destined to the UE 352 through the new DU 320.

In the second scenario, the source and target (new) DUs 320 are in different gNBs 300. In this case, both the DU 320 and the CU 310 of the target gNB 300 execute respective AC processes to accept or refuse the coupling to the UE 352, based on the availability of the resources of the target gNB 300. If the target DU 320 and CU 310 accept the coupling to the UE 352, the target CU 310 may route traffic to and from the DU 320 through the Xn interface 415 to the source CU 310, which continues to handle traffic forwarding through the NG interface 335 to the CN 330.

The three models illustrated in FIGS. 3-5 give rise to various scenarios for capability exposure and AC, which will be discussed in greater detail below.

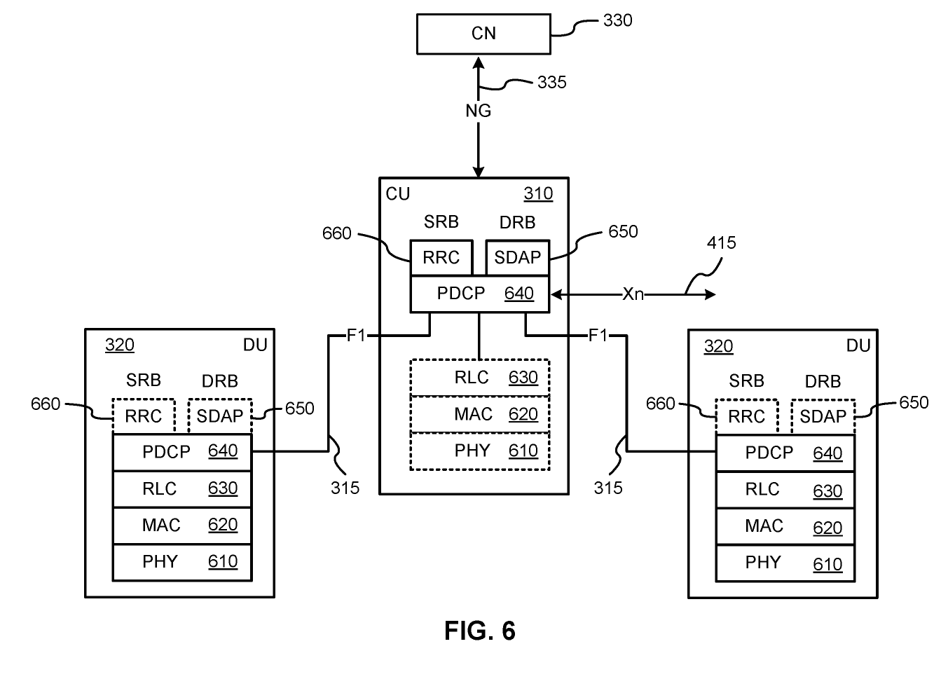

Referring to FIG. 6, the Uu interface 325 between a UE 352 and a RAN node 400 may comprise several entities within the protocol stack. Example entities include:
physical layer (PHY) 610, which encodes information for transmission over the radio link;
medium access control (MAC) 620, which performs scheduling of radio resources according to traffic demands, multiplexing of MAC 620 PDUs belonging to one or different logical channels onto PHY 610 transport blocks, and error correction through Hybrid Automatic Repeat Requests (HARQ);
radio link control (RLC) 630, which performs segmentation and reassembly of RLC 630 PDUs for mapping onto PHY 610 transport blocks, and provides error recovery through automatic repeat requests (ARQ);
packet data convergence protocol (PDCP) 640, which performs header compression and decompression for IP packets, in-sequence delivery of upper layer PDUs, PDCP 640 PDU routing for transmission, duplicate packet detection, retransmission of lost PDCP 640 PDUs, cryptographic integrity protection and encryption;
service data adaptation protocol (SDAP) 650, which performs routing of quality of service (QoS) flows onto the appropriate DRB. A QoS flow may comprise an aggregation of UP traffic receiving the same forwarding treatment (e.g. scheduling policy, queue management policy, rate shaping policy, RLC 630 configuration, PDCP 640 configuration). Providing different QoS forwarding treatment involves a different QoS flow; and
radio resource control (RRC) 660, which performs configuration of radio resources assigned to a UE 352, configuration of radio bearers for information exchange, management of radio link security associations, paging, measurement reporting, handover, and transport for non-access stratum signaling.

CP information such as RRC and non-access stratum (NAS) signalling may be carried over an SRB while UP data may be carried over a DRB. In a CU-DU split gNB 300, each of the CU 310 and DUs 320 may include all of the above-mentioned protocol stack entities. FIG. 6 illustrates an example in which both of the CU 310 and DUs 320 include the entire protocol stack, but the lower layers (PHY 610, MAC 620 and RLC 630) are only used in the DUs 320. In this case, the F1 interface 315 is defined between the PDCP 640 entities of the DUs 320 and CU 310, which implies that the AC function is also part of (or associated with) the PDCP 640 protocol stack entity.

The 3GPP 5G technical standards introduce the concept of splitting the functionality of gNBs 310 between CU 310 and DU 320 entities. In some examples, most RRC 660 functions (e.g. user related) may be implemented within the CU 310, while most RRM functions (e.g. cell management) may be implemented within the DUs 320. However any decisions here impact different demands for capability exposure of each node, and another way to decide location of function is to observe what information/capabilities may be exposed and the complexity of exposing those capabilities.

Thus, in order to stimulate discussion of where gNB 300 functionality may conceptually be allocated, as between the CU 310 and DU 320, a non-limiting list of information types or capabilities, that could be used by one or more functions at either or both of a CU 310 and DU 320, is provided, together with, in certain cases, example scenarios in which such capabilities could be employed. It should be noted that the identification of a capability as a CU 310 capability or a DU 320 capability should not necessarily be interpreted as a suggestion that exposure of such capability by the CU 310 or DU 320, as the case may be, is appropriate. That is, the pertinence of actually supporting exposure of any of the following information elements is not discussed herein.

Capabilities that may be allocated to or exposed by the CU 310 may include, without limitation:
traffic processing capability, which could be exposed differently to different DUs 320 (for slicing purposes) or could vary for different parameters, including without limitation, robust header compression (RoHC), encryption, acknowledge mode (AM), unacknowledged mode (UM) or handover demands, including without limitation:
   number of active sessions,
   maximum rate,
   latency, or
   QoS treatment capabilities for different service types;
dynamic loading status, which could be expressed in terms of, without limitation:
   a percentage of maximum allocated resources of the CU 310 to one DU 320,
   a number of additional sessions that the CU 310 can support of one type of QoS, or
   an abstract amount of remaining or used resources, which may be expressed in terms of a common resource unit;
max round trip time for proper PDCP 640 functions (for AM) that can be supported, which could include, without limitation:
   a maximum CU-DU link latency, or
   an over-the-air (OTA) latency;
at least one of optimization or performance capability, which supposes that the CU 310 is in charge of managing, has knowledge of and is capable of configuring the multiple DUs 320, such that they work well together, minimizing interference and balancing load, or deriving fractional frequency re-use (FFR) strategy, including without limitation:
   multiple legs (how many/under what circumstances) or dual connectivity (DC),
   handover capability (by way of non-limiting example, 0 ms to other DU 320, in order or guaranteed delivery between DUs 320, between CUs 310 and/or between gNBs 300), or
   load balancing/interference management/self-organizing networks (SON) optimization capabilities;
mobility capabilities or location, in that the location of a CU 310 may influence how well suited it is to deal with mobility, in the same way that different cells' connectivity may take into account the type (pico/small/macro) or coverage region of a cell. By way of non-limiting example, a CU 310 could be in a local mobile edge computing (MEC) cell and therefore not well suited for the connectivity of a fast moving UE 352, relative to a CU 310 in a remote data centre. In some examples, mobility capability information element may be phrased in terms of the capability of the DU 320, as opposed to simply sharing a location, given that the location may be a virtual location;
connectivity type, including without limitation, local breakout support or MEC;
neighbor cells (if the CU 310 houses an automatic neighbor relation (ANR) function or an SRB function);
network connectivity, in which CUs 310 could be coupled to have access to only certain slices or access and mobility management function (AMF) nodes—in this context, DUs 320 would make the decision of which CU 310 to be coupled to for an incoming connection provided the network slice selection assistance information (NSSAI)/slice is received from the UE 352 and the DU 320 can read the RRC message;
other DU 320 connectivity for purposes of DU 320 automatic neighbouring discovery, reflecting that not all DUs 320 in a location may be reachable by the same CU 310).

Capabilities that may be allocated to or exposed by the DU 320 may include, without limitation:
bandwidth or frequency attributes, including without limitation:
   technical capabilities,
   modulation scheme (including, without limitation, 256 quadrature amplitude modulation (QAM)),
   multiple in/multiple out (MIMO) antenna configurations, or
carrier aggregation capabilities;
QoS capabilities, including without limitation:
   maximum rates,
   latency capabilities,
   supported QoS class identifiers (QCI), (including, without limitation, QCI type A), or
   service type (including, without limitation, ultra-reliable, low latency communications (URLLC), MTC, enhanced mobile broadband (eMBB));
radio access technology (RAT) type (while the DU 320 discussed herein is a 5G DU 320, it is conceivable that other RATs could be to a 5G (or later evolution) DU 320. Indeed, it is conceivable that in 5G technology, one way to implement LTE wide area network access (LWA)/LTE wide area IP secure network (LWIP) capability is to provide 802.11 network connectivity at the DU 320);
number of simultaneous UE connections supported;
cell type, including without limitation:
   indoor/outdoor, or
   macro/small/pico/home nodeB, etc.
coverage type, including without limitation:
   available power,
   antenna height, or
   coverage information that can enable another node such as the CU 310 to evaluate whether using the DU 320 will impact interference or loading of other DUs 320, including without limitation, beamforming capability/sectorization capability/omni;
SON capabilities, including without limitation, FFR or inter-cell interference coordination (ICIC);
resource allocation configurability, including without limitation, scheduling configurability, hard slicing or soft slicing;
neighbouring cells if managed at DU 320 (obtained by automatic neighbor relations); or
other capabilities, including without limitation,
   number of remaining QoS type sessions that could be supported,
   single percentage of loading (relative to what is known by the CU 310 about the active PDU sessions, while recognizing that it may be conceivable that the DU 320 may be coupled to multiple CUs 310, in which case, such percentage should relate to a given CU 310 and the DU 320. By way of non-limiting example, if the DU 320 is hard-sliced in resources and one PDU session consumes 50% of the allocated resources for a given CU 310, then the DU 320 would expose 50% loading to such CU 310. On the other hand, again by way of non-limiting example, if the DU 320 is not hard-sliced, the DU 320 could expose 25% to each of two CUs 310 until one of such CUs 310 accesses a greater amount of resources, or
   a resource equivalent unit, where all types of QoS' requirements are translated into this unit with known conversion formula for the CU to know whether it can add, by way of non-limiting example, one URLLC PDU session or two eMBB or 200 MTC of a given QoS demand.

In addition to the foregoing, where a given function is allocated as between the CU 310 or DU 320 (or both, where there is a split of functionality or some sort of handshaking) may impact what information is shared. A few non-limiting examples of such functions are set out herein:
Handover decision:
   If located at the CU 310, the CU 310 will know the capability of the DU 320, but could centralize loading information and improve decision-making latency;
   If located at the DU 320, the DU 320 has the best knowledge about the signal condition and the DU loading, but would query neighbouring DUs 320;
   If shared between the CU 310 and the DU 320, may add unnecessary round trip times as opposed to exposing capabilities beforehand and centralizing decisions;
Admission control:
   If located at the CU 310, the CU 310 will know the remaining resources of the DU 320;
   If located at the DDU 320, the DU 320 will know the traffic processing capabilities of the CU 310;
   If shared between the CU 310 and the DU 320, may add unnecessary round trip times as opposed to exposing capabilities beforehand;
Requesting additional resources:
   If located at the CU 310, if the DUs 320 expose capabilities, the CU 310 can rapidly make a decision to add a leg to support a more demanding QoS, but should have the same knowledge as AC and other technical information (RAT or frequencies);
   If located at the DU 320, would simplify the decision-making demands of the CU 310, but would involve the DU 320 acting almost like a gNB 300 and request the CU 310 to establish a new link;
   If shared between the CU 310 and the DU 320, the CU 310 could act as a master node and query the DUs 320 in a given preference order to determine whether a leg can be added. This supposes that the CU 310 knows the list of cells or DUs 320 that the UE 352 sees;
Selecting AMF:
   If located at the CU 310, the SRB ends at the CU 310 and the CU 310 knows the NSAAI/slice ID. On the other hand, if the CU 310 is not able to talk to the proper AMF, how would it offload to another CU 310?
   If located at the DU 320, the SRC ends at the DU 320 and the DU 320 has to know which CU 310 can reach which AMFs;
   If shared between the CU 310 and the DU 320, the DU 320 could have partial knowledge to make a better first guess as to which CU 310 to choose and the CU 310 would choose the AMF or else request CU 310 handover;
SON/power allocation/FFR strategy/ABS:
   If located at the CU 310, the interference information from the DUs 320 is centralized and the CU 310 establishes a possibly joint FFR/ICIC or traffic optimization strategy;
   If located at the DU 310, the DU 320 acts like a gNB 300, while the CU 310 has no visibility of this. The F1 interface is not defined, apart from a piggy-backed Xn message to the DUs 320 for SON purposes;
   If shared between the CU 310 and the DU 320, the CU 310 may handle load balancing by redirecting. The DU 320 handles FFR/ICIC. Some mechanism may be added over F1 to enable the CU 310 to know the impact of moving traffic from one DU 320 to another DU 320.

A number of strategies for exposing each of these functions and capabilities may be employed once a CU 310 is coupled to a DU 320 by a link. In general, there are two extremes to exposing capabilities. In some respects the selected strategy may extend somewhere along a continuum between two extreme scenarios.

One extreme is to not expose any information or capabilities, leaving each CU 310 or DU 320 to make a decision on AC based solely on information of the resources that it owns, as the occasion presents itself for the resources allocated to them. This scenario may be suitable, by way of non-limiting example, where geographically distinct DUs 320 cover a region under a common CU 310. It would not be optimal in situations of optimizing node selection or handover or where latency may be an issue.

The other extreme is to expose all capabilities, allowing the other CU 310 or DU 320 to make some decisions (since it knows the other's capabilities) based upon its understanding of the capabilities exposed to it and to choose a (different) connectivity pattern. Such a scenario allows for a fully distributed location of functions, especially control functions and may be suitable in a meshed network comprising multiple CUs 310 located remotely or locally in different geographical zones, as well as DUs 320 covering exclusive or overlapping geographical zones, where most CUs 310 are able to access a plurality of DUs 320 or most DUs 320 are able to access a plurality of CUs 310. Such a topology would simplify deployment since it offers greater reliability to the network while not calling for as much planning. However, such a scenario would presumably involve a standardization of the F1 interface in order to define every conceivable information element.

Alternatively, an intermediate, evolutionary strategy could be employed, in which a minimum or initial set of definitions of capabilities or function locations may be predetermined or chosen, to minimize the amount of standardization of the interface and/or to facilitate initial design and deployment of, by way of non-limiting example, the F1 interface 315, with the possibility of gradual augmentation by adding elements to be exposed as benefits become more apparent.

In some examples, certain capabilities could be identified as mandatory for exposure to ensure proper functionality of the gNB 300 concept. Other capabilities could be voluntarily exposed. In some examples, a query could be posed as to a given capability with the understanding that a potential response could be “not supported”.

In this context, the notional capability exposure scenario is one in which a CU 310 is coupled to a DU 320 by a link 315, such as an F1 interface. At some point in time thereafter, the CU 310 is exposed to capabilities of nodes coupled to it, such as the DU 320 along the link 315, and the DU 320 is exposed to capabilities of nodes coupled to it, such as the CU 310 along the link 315.

It will be appreciated that the CU 310 may also be exposed to capabilities from other entities, nodes or sub-nodes coupled to it by a link, including the CN 330 along a NG interface link 335 or other DUs 320 along other F1 or other interface links 315. In addition, the CU 310 may also be exposed to capabilities from other gNBs 300 along an Xn interface link 415.

Similarly, it will be appreciated that the DU 320 may also be exposed to capabilities from other entities, nodes or sub-nodes coupled to it by a link, including a UE 352 along a Uu interface link 325 or other CUs 310 along other F1 or other interface links 315. In addition, the DU 320 may also be exposed to capabilities from gnBs 300 along an Xn interface link 415.

Still further, while it is understood that information is exposed across established (F1 or F1-AP) links 315, between a CU 310 and a DU 320, by way of non-limiting example, information may be exposed only between established F1-AP links 315, implying that a CU 310 may expose information only to its coupled DUs 320, and a DU 320 may expose information only to its coupled CU(s) 310, it is conceivable that a CU 310 could expose capabilities to other CUs 310 within a given or defined location or across locations, such as, without limitation, CUs 310 at a local MEC or at a remote cloud. CUs 310 could be configured by a MP with a pre-configured set of CUs 310 to know which other CUs 310 to talk to or could have an automatic discovery capability using, without limitation, IP methods or DNS or border gateway protocols to ascertain which CUs 310 are reachable by their network connection.

Moreover, DUs 320 could be exposed to other DUs 320 in the form of pre-configured sets of DUs 320 or DUs 320 detected by automatic neighbor relations.

CUs 310 and DUs 320 may be configured to expose capability information at any suitable time. There are a number of instances at which capabilities can be exposed.

A first such instance is upon a specific trigger, for example, without limitation, automatically upon establishment of the F1-AP interface link 315 between a CU 310 and a DU 320, a trigger from a DU 320 indicating, without limitation, a UE 352 mobility event (including without limitation, arrival or departure), or a signal strength change above a threshold value or a UE 352 status change (including without limitation, RRC 660 mode (inactive/active/idle/mobile initiated communication operation (MICO))) or a trigger from a CU 310 indicating, without limitation, establishment of a new PDU session or a CN 330 UP traffic path switch.

A second such instance is upon request, for example, an entity, such as, the CU 310 or the DU 320 requesting, across the F1 interface link 315, a status report of all capabilities, a condensed report of changes since a last request or a report of a single capability of a given type.

A third such instance is periodically. By way of non-limiting example, a CU 310 or a DU 320 could request a report of one or a bundle of capabilities to be periodically reported.

It will be appreciated that while the present discussion is framed in terms of a first entity exposing capabilities to a second entity coupled to it by a link, it will appreciated that it thus follows that at the same time, the second entity accesses the capabilities exposed by the first entity.

In some examples, the capabilities exposed by the first entity to the second entity may include some or all of the capabilities of other entities accessed by the first entity.

In some examples, the architecture of the CU 310-DU 320 combination (notionally the gNB 300) may impact the exposure of capabilities.

In a first example, the CU 310 has little intelligence and/or is provided with limited processing resources. In this example, the DU 320 would have knowledge of all traffic processing capabilities of the CUs 310 and their connectivity and would select a given CU 310 for a given requested PDU session. In other words, the DU 320 establishes the connections and will request that the CU 310 expose its capabilities for handling PDCP traffic.

In a second example, the DU 320 would make no control decisions, no handover and no admission control. The DU 320 would only be responsible for the scheduling of packets in the RLC 630 buffer. In such an example, the DU 320 would only expose to the CU 310 its current loading and ability to support QoS to permit the CU 310 to make all decisions.

In a third example, every decision results in a query to the other node for respective controlled resources, that is, there is no exposure of capabilities. In such an example, capability exposure is replaced with queries that answered by a yes/no response, which would add to the latency by having to query the node after the fact during connection set-up, rather than making a decision based on capability information previously received from the other node. A non-limiting example would be when the DU 320 relays the connection set up to the CU 310 for a new UE 352. The CU 310, after receiving information from the core network 330 for that UE 352, would query the DU 320 for its ability to support the requested QoS.

In a fourth example, all entities always share and advertise everything to all other nodes. In this way, a DU 320 can immediately take a decision, such as, without limitation, that a neighbor DU 320 is better suited to have a UE 352 handed over to it. At the same time, the CU 310 can immediately take a decision that a new requested PDU session can be supported by a given DU 320 for a UE 352. In such an example, since CU 310 capabilities are exposed to all other CUs 310 and all DUs 320 and DU 320 capabilities are exposed to all other DUs 320 and all CUs 310, a given node, such as a CU 310 is able to determine when it is no longer optimal and will handover to another CU 310 and inform path switches to the DUs 320. This strategy would also expose CU 310 capabilities to other CU(s) 310 and to DU(s) 320 and DU 320 capabilities to CU(s) 310 and to other DU(s) 320, such that, by way of non-limiting example, if the CN 330 requests a path switch, the CU 310 can determine whether or not it is still the optimal CU 310. If another CU 310 is better, it can automatically initiated handover to that CU 310 and trigger path switches to involved DUs 320.

In a fifth example, some capabilities are exposed and nodes are not precluded from making decisions provided they have sufficient information. In some cases, a second node may reply with a denial if the decision taken is inappropriate. In such an example, each node assumes responsibility to evaluate how much information it has and whether or not to take a decision in the face of incomplete knowledge.

### Admission Control

AC involves evaluating the current capabilities of the gNB 300 to know whether a new incoming session can be supported for the requested QoS.

In LTE, the eNB would control a number of possibly overlapping cells, such as, by way of non-limiting example, different frequencies. Then, small cell deployment with DC could enable one master gNB 300 to easily handover UEs 352 from small cell to small cell, while keeping a macro cell active.

In a CU-DU split gNB 300, DUs 320 can act as small or pico cells offering different bandwidth, or different (versions of) RATs and capabilities. The CU/DU model may thus be employed to gradually deploy more dense or upgraded networks. If AC is in the CU 310, the CU 310 will have a minimum knowledge of the capabilities of its DUs 320.

By way of non-limiting example, one DU 320 may provide a better signal to a UE 352, and this DU 320 would reject AC based on QoS constraints. However, if the CU 310 knew that a second DU 320 had similar coverage and currently had loading and QoS capacities that allowed for support of the new session request, the CU 310 could manage load balancing and redirect the new UE 352 to the second DU 320, without refusing first the connection set-up and forcing the UE 352 to find the cell of the second DU 320.

Three AC function types may be defined, each with different consequences, as follows:
the CU 310 is fully in charge of making the AC decision. The CU 310 knows the current (and/or remaining) capabilities of each DU 320 at all times;
the DUs 320 are fully in charge and act as current eNBs 52, stripped of a high layer UP function. This provides little change to current standards and leaves the RRC 660 in the DU 320, simplifying the F1 interface 315. But this also reduces performance of the load balancing and session admission processes, mostly by adding delays of interactions between UE 352 and multiple DUs 320;
there is a shared AC responsibility and the AC function is not fully located in either the CU 310 or the DU 320. Rather, each CU 310 and DU 320 has clear responsibilities on what contribution it makes to AC and both entities interact to make the AC decision.

### Different Information Elements Employed in the Connection Set-Up/Session Request

From the UE 352, an NSSAI or slice ID is provided. This could be used to decide whether the UE 352 is camping on an appropriate DU 320 or should be handed over to another DU 320. Furthermore, a DU 320 could be configured, by way of non-limiting example, by the MP, to provide access to certain slices only. Since the DU 320 does not know the slice to which the UE 352 is trying to couple before (at least) receiving the NSSAI/slice ID, it does not bar the UE 352 from trying to couple to an unsupported slice. As well, CUs 310 could be restricted to certain slices and may have access to only some parts of the core network (including only some AMFs). This would likely impact how a DU-CU combination could respond to an incoming connection or session.

The cell's SI could make a first selection of which (types of) UEs 352 can couple to one DU 320 or another. The fact that a UE 352 has coupled to one DU 320 is information that the CU 1310 can use (along with the NSSAI/slice ID) in order to choose an AMF.

The DU 320 may have technical limitations, including without limitation, QoS capabilities (is it able to have URLLC, eMBB, MTC and/or SFN broadcast?), frequency support and/or carrier aggregation (which, being done at the MAC 620 layer, is a DU-only function).

A DU 320 may have mobility support limitations, including without limitation, being a small or pico cell to which UEs 352 with high speed mobility patterns should avoid coupling.

An important factor for AC is the run time capabilities of a DU 320, including without limitation and/or the amount of loading, the number and/or kind of QoS sessions it can/could handle (which may also depend also on radio signal quality).

CUs 310, on the other hand, can also have capability limitations, such as, by way of non-limiting example, being perhaps only able to process a given number of simultaneous PDU sessions of certain QoS types.

One DU 320 may see multiple CUs 310, with the result that a DU-CU combination is chosen during connection set-up and/or AC. This may result in CU handover and/or a redirection at connection set-up, even without a change in DU.

### Location Strategy

### Centralized AC

In examples in which the CU 310 makes all AC decisions, the CU 310 should have sufficient knowledge to process a new session request.

At the very least, with the AC decisions centralized in the CU 310, the CU 310 should know the currently available DU 320 resources, in order to accept a connection or a new session on behalf of such DU 320. In other words, DUs 320 should expose their dynamic loading and/or remaining capabilities and/or resources.

For more versatility (of variability of deployed DU 320 technology), CUs 310 would make a better decision with the knowledge of QoS handling capabilities of DUs 320. This could be in the form of, by way of non-limiting example, supported type A QCI and/or service type (including without limitation, URLLC, eMBB, MTC and the like).

For mobility types, the CU 310 would benefit from knowing to what type of DU 320 it is coupled, in order to differentiate, by way of non-limiting example, a macro deployment type from a pico and/or small cell.

With all the information available at the CU 310, the CU 310 can make an AC decision on behalf of the DU 320 and immediately continue with SRB and/or DRB initialization right after receiving the connection and/or session set-up answer from the CN 330.

It may be observed that with the AC decision in the CU 310, most optimization, for load balancing, is easily applied in the CU 310. However the CU 310 should know quite precisely the status of the DUs 320 in order to make AC decisions for them. The connection latency is reduced by one CU-DU round trip time, compared to other scenarios.

### DU Located AC

If the CU 310 remains only a UP remote hub, then the DU 320 knows most of the information and makes all the decisions and knows mostly.

Nevertheless, there remain some things that may still affect the AC decision made by the DU 320:
Unless the SRBs end at the DU 320, the CU 310 is the end point of RRC 660 messaging. Accordingly, the CU 310 would still be the entity interfacing with the CN 330 and the CU 310 relays information about the connection expectation of the UE 352, to the DU 320 for it to decide on AC. This includes the type of network to which the UE 352 wants access (by way of non-limiting example, SFN and/or URLLC), and perhaps capabilities such as, by way of non-limiting example, carrier aggregation.
The CU 310 also informs the DU 320 of its current capabilities, either at connection request and along with the response from the CN 330 AMF. The CU 310 informs, by way of non-limiting example, that it can support the UE 352 and its PDU sessions with requested QoS parameters, or that it can only provide partial (or no) support. This information could however be pre-emptive, especially in the case where the DU 320 sees multiple CUs 310 with different capabilities and/or current loading. With such information, the DU 320 can first decide to choose an available CU 310 to manage the traffic, then receive the connection response after the new connection/session has been requested from the CN 330. Further on, the DU 320 can decide to handover to another CU 310 with such connection/session demands to match the capabilities of the CUs 310, without having to independently query each attached CU 310 until one is found. In this case, capabilities exposed to the DU 320 could include, by way of non-limiting example, slice connectivity of the CUs 310 and/or QoS capabilities (that is, an ability to handle a given amount of traffic).

An alternate architecture (although currently excluded by agreements) is that where the SRB finishes entirely in the DU 320, so that there is little information exchanged by the DU 320 with the CU 310. The DU 320 only knows capabilities of the CUs 310 and the DU 320 manages, without limitation, all the RRC signalling and/or selection of AMFs.

Finally, the DU 320 would perform AC and advise the CU 310 to proceed with the SRB/DRB set-up.

It may be observed that locating the AC decision in the DU simplifies the F1 interface 315 by sharing only sufficient capability information for the DU 320 to know that the CU 310 supports a session. Since the DU 320 manages most of the aspects that impacts AC (including, without limitation, scheduling capabilities and/or AI loading), it is simpler to let the DU 320 decide. However, this incurs an extra round trip latency from the CU-DU and the CU 310 will not quickly reselect a more adequate DU 320.

### Hand-Shake Admission Control

In a hand shake method, the CU 310 and DU 320 do not exchange first information about their capabilities in order for one or the other entity to make the AC decision. Rather, each owns its own resources and accepts or refuses admission based on these resources. Instead, they forward constraints received by the CN 330 AMF only, and each entity to make its own AC decision.

The CU 310 receives the connection and/or session set-up answer from the CN 330 and accepts or rejects it based on its known capabilities. The CU 310 then forwards this decision to the DU 320, which in turn replies to the UE 352 with, as appropriate, a rejection, or an acceptance or rejection after evaluating its own capabilities given the demands of the UE 352, which it forwards both to the UE 352 and the CU 310.

Alternatively, and in order to support more flexibility in the case of an arrangement of multiple CUs 310 associated with a common DU 320, the DU 320 would receive the demands of the UE 352 even if the CU 310 has rejected admission. The DU 320 could then, if it can accept the UE 352, try to query other CUs 310 for admissibility. In this case, the F1 interface 315 would support such extra query for AC from the DU 320 to other CUs 310. In such a mechanism, no decision capabilities are handed over, precluding load balancing.

In a deployment scenario where each DU 320 provides clear frequencies and technical capabilities for the UE 352 to wisely chose its cell, and where each DU 320 provides different geographical coverage, and also where each DU 320 is attached to only one CU 310, then this mechanism is as efficient as the other and does not increase the number of messages exchanged over the F1 interface 315 during connection and/or session set-up. However, for flexible deployments where DUs 320 are gradually added for more capabilities and improved coverage and where such DUs 320 may be attached to multiple CUs 310, this mechanism under performs as it prevents a CU 310 or a DU 320 to select a CU 310 or redirect to a CU 310 and DU 320 combination more efficiently at connection and/or session set-up.

It may be observed that the “hand shake” AC method where each CU 310 and DU 320 makes decisions for its own resources simplifies the F1 interface 315 by minimizing the exchange of capability exposure messages, but adds one query from the CU 310 to the DU 320. Further, the CU 310 has to wait for the response from the DU 320.

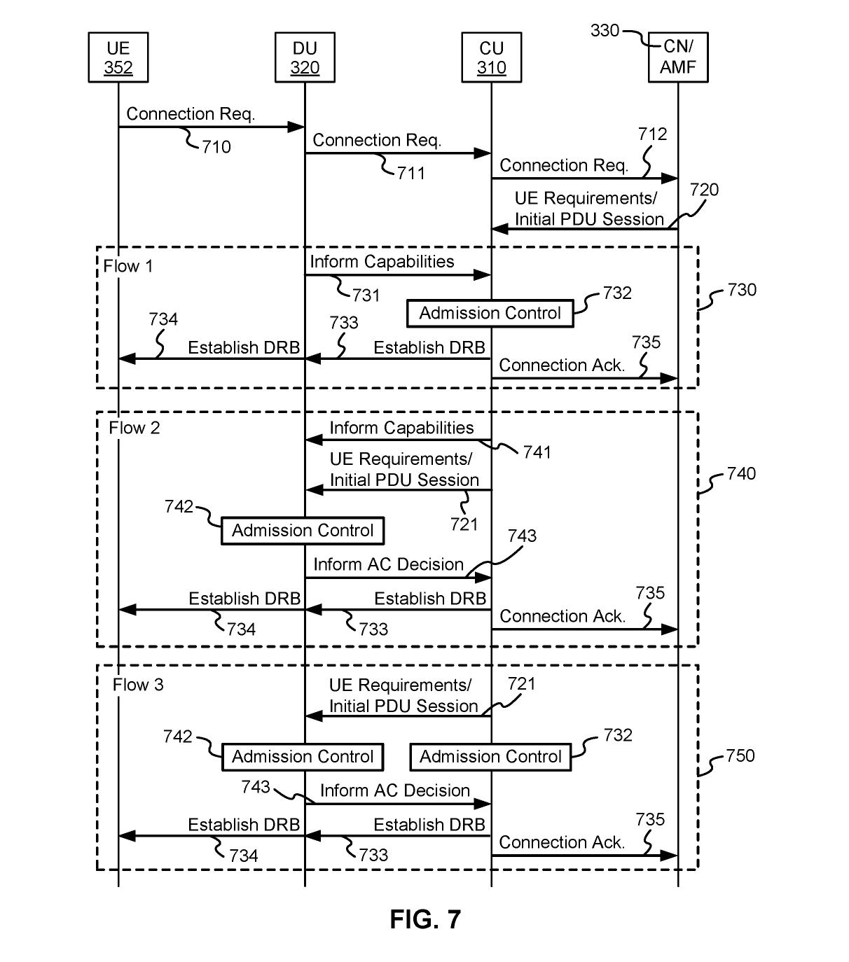

FIG. 7 is a message flow diagram illustrating the three above-described locations of the admission control decision. In FIG. 7, Flow 1 730 corresponds to the CU-Located AC; Flow 2 740 corresponds with the DU-Located AC, and Flow 3 750 corresponds with the Handshake AC.

The figure shows messages exchanged between the UE 352, DU 320, CU 310 and the CN 330/AMF.

The UE 352 issues 710 a connection request to the DU 320, which forwards it 711 to the CU 310, who in turn forwards it 712 to the CN 330/AMF. The CN 330/AMF returns 720 an initial PDU session with associated UE demands to the CU 310.

In Flow 1 730, the DU 320 informs 731 the CU 310 of its capabilities and the CU 310 makes the AC decision 732. The CU 310 then establishes 733 a DRB that it forwards to the DU 320, who in turn forwards it 734 to the UE 352. The CU 310 then acknowledges the connection 735 by sending a message to the CN 330/AMF.

In Flow 2 740, the CU 310 informs 741 the DU 320 of its capabilities and forwards 721 the initial PDU session with associated UE demands to the DU 320. The DU 320 then makes the AC decision 742 and informs 743 the CU 310 of the AC decision made by it. The CU 310 then establishes 733 a DRB that it forwards to the DU 320, who in turn forwards it 734 to the UE 352. The CU 310 then acknowledges the connection 735 by sending a message to the CN 330/AMF.

In Flow 3 750, the CU 310 forwards 721 the initial PDU session with associated UE demands to the DU 320. The DU 320 then makes its own AC decision 742 and informs 743 the CU 310 of the AC decision made by it. At the same time, the CU 310 makes its own AC decision 732. The CU 310 then establishes 733 a DRB that it forwards to the DU 320, who in turn forwards it 734 to the UE 352. The CU 310 then acknowledges the connection 735 by sending a message to the CN 330/AMF.

### Different Handover Scenarios and Impacts

### DU-DU Handover, No CU Change

The most common handover scenario is of a handover from one DU 320 to another DU 320 without changing the associated CU 310. Since the CU 310 is unchanged it may be used to initiate the handover. However, the DUs 320 are directly measuring the signal strength of the UE 352, and may be closer to one another, with lower latency if they are directly coupled as opposed to the DU-CU latency for a CU 310 that is located in a remote DC. Therefore, there could be different scenarios for a DU-DU handover with various performance impacts.

By way of a first non-limiting example, the UE 352 could be configured by the RRC 660 in the CU 300 to report the signal strength of a set of DUs 320 and the handover would be initiated by the CU 310 given those signal strengths. The SRB of this RRC 660 would be terminated at, or relayed to, the CU 310.

Alternatively, the DU 320 could be configured to query neighboring DUs 320 if its signal strength is reduced below a threshold. A second DU 320 could reply with a “please handover to me” message and immediately pass on the context that it has. The second DU 320 could start relaying the uplink and inform the CU 310 to switch paths. Until the path switch is applied, the first DU 320 would forward downlink packets received by it. This scenario works well if the DU-DU interface has a better latency than the CU-DU interface.

### CU-CU Handover, No DU Change

In some circumstances, the CU 310 could be changed while keeping the traffic flowing through the configured DUs 320. By way of non-limiting example, load balancing of a DC may cause certain CUs 310 to be turned off and handed over to other CUs 310. Alternatively, one CU 310 may be moved from a remote DC to a local MEC in order to add a session for a UE 352.

Such a handover does not intensively involve the DU 320, as the DU 320 recognizes a path switch. Depending on where the relevant information lies, the DU 320 could be more involved. By way of non-limiting example, the DU 320 may be coupled to multiple CUs 310 and may be better suited to hand over to a second CU 310 without any CU-CU interaction. The DU 320 would forward the UE 352 context from the first CU 310 to the second CU 310. Alternatively, if the UE 352 is served by multiple DUs 320, it may be preferable if the CU 310 handles the handover process. In a further alternative, the CU 310 could select one DU 320 to proxy the handover of the UE 352 context to a second CU 310.

### CU-DU Handover

In some scenarios, the CU-DU handover corresponds with a gNB 300 handover. A single entity is in charge of signaling over the Xn link 415 of the gNB 300 for a RAN gNB handover. In that case, the DUs 320 provide their context for radio management to the CU 310 which then effects the handover.

In some examples, a DU-DU interaction for a CU-DU handover is desirable, such as, by way of non-limiting example, if a UE 352 is moving from one PLMN to a visiting PLMN, where the first DU 320 and second DU 320 actually have a lower latency connection. In such case the CU 310 may also change.

Finally, a CU-DU handover could be broken up into respective CU-CU and DU-DU handovers in a completely meshed CU-DU split.

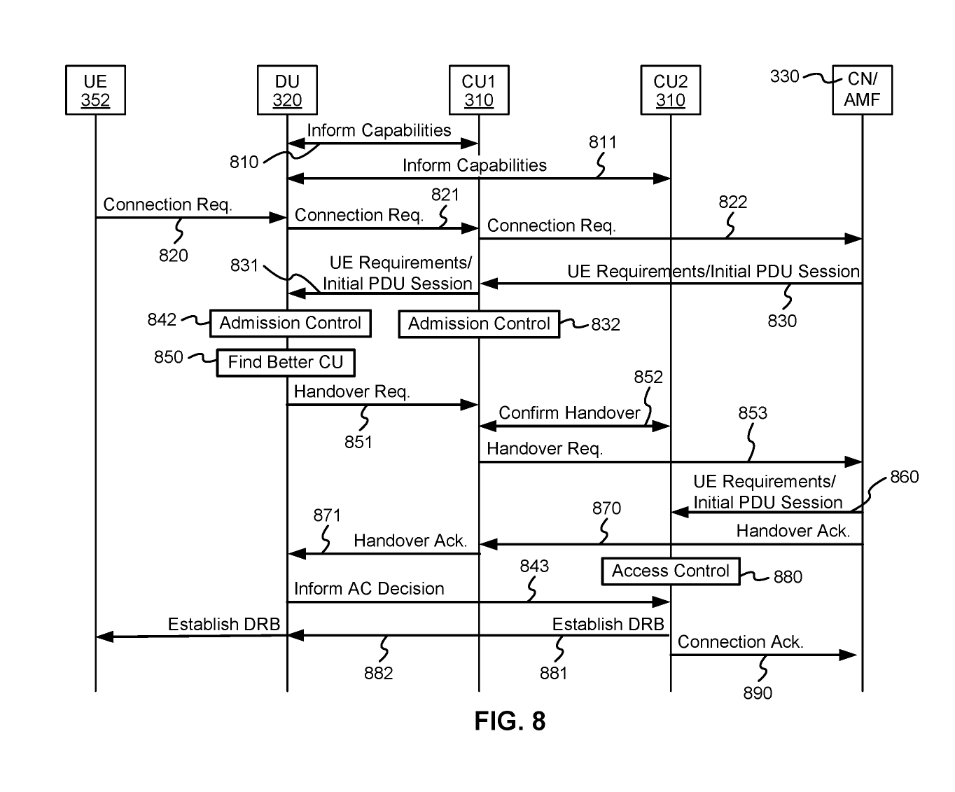

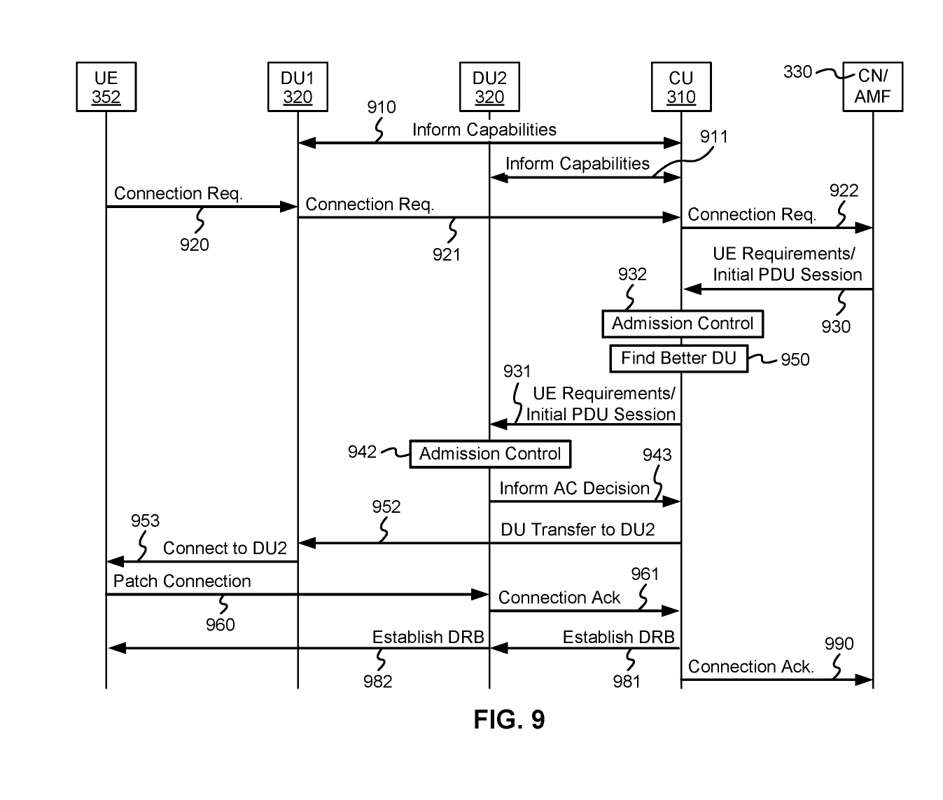

In some miscellaneous situations, the DUs 320 and CUs 310 may have different visibility of information and capabilities of other nodes. This is illustrated in FIGS. 8 and 9.

FIG. 8 is a message flow diagram illustrating a capability exchange scenario in which each of the CU 310 and DU 320 have partial knowledge of the other's available capabilities, and where the DU 320 has information about other CUs 310 that the first CU 310 does not. In the illustrated scenario, the DU 320 exchanges (partial) capability information (by way of non-limiting example on a periodic basis) with two CUs 310 (respectively designated CU1 and CU2). When a connection request is received, both the DU 320 and CU1 310 perform AC using the hand-shake method. However, the DU 320 is also able to identify that CU2 310 is better suited to the new connection. In this case, the DU 320 can trigger a handover from CU1 310 to CU2 320, which then completes AC and establishes the desired connections.

The figure shows messages exchanged between the UE 352, the DU 320, CU1 310, CU2 320 and the CN 330/AMF.

The DU 320 and CU1 310 expose and exchange capabilities 810 with each other. Similarly, the DU 320 and CU2 310 expose and exchange capabilities 811 with each other.

The UE 352 issues 820 a connection request to the DU 320, which forwards 821 it to CU1 310, who in turn forwards 822 it to the CN 330/AMF. The CN 330/AMF returns 830 an initial PDU session with associated UE demands to the CU 310, which forwards it 831 to the DU 320.

The DU 320 then makes its own AC decision 842 and at the same time CU1 makes its own AC decision 832.

The DU 320 determines 850 that CU2 310 may be better suited to support the UE 352 and its connection request. The DU 320 sends 851 a handover request to CU1 310. CU1 310 coordinates 852 with CU2 310 to confirm the handover. Consequently, CU1 1310 issues a handover request 853 to the CN 330/AMF.

The CN 330/AMF returns 860 an initial PDU session with associated demands to CU2 310.

The CN 330/AMF acknowledges 870 the handover to CU1 310, who in turn forwards it to the DU 320.

In the meantime, CU2 310 performs access control.

The DU 320 then informs 843 CU2 310 of the AC decision made by it.

CU2 310 establishes 881 a DRB that it forwards to the DU 320, who in turn forwards it 882 to the UE 352.

CU2 310 then acknowledges the connection 890 by sending a message to the CN 330/AMF.

FIG. 9 is a message flow diagram illustrating a capability exchange scenario in which each of the CU 310 and DU 320 have partial knowledge of the other's available capabilities, and where the CU 310 has information about other DUs 320 that the first DU 320 does not. In the illustrated scenario, the CU 310 exchanges (partial) capability information (by way of non-limiting example on a periodic basis) with two DUs 320 (respectively designated DU1 and DU2). When a connection request is received, both DU1 320 and the CU 320 perform AC using the hand-shake method. However, the CU 310 is also able to identify that DU2 320 is better suited to the new connection. In this case, the CU 310 can trigger a handover from DU1 320 to DU2 320, which then completes AC and enables the CU 310 to establish the desired connections.

The figure shows messages exchanged between the UE 352, DU1 320, DU2 320, the CU 310 and the CN 330/AMF.

DU1 320 and CU1 310 expose and exchange capabilities 910 with each other. Similarly, DU2 320 and the CU 310 expose and exchange capabilities 911 with each other.

The UE 352 issues 920 a connection request to DU1 320, which forwards 21 it to the CU 310, who in turn forwards 922 to the CN 330/AMF. The CN 330/AMF returns 930 an initial PDU session with associated UE demands to the CU 310.

The CU 310 then makes its own AC decision 932.

The CU 310 determines 950 that DU2 320 may be better suited to support the UE 352 and its connection request. The CU 310 then forwards the initial PDU session with associated UE demands to DU2 320.

DU2 320 then makes its own AC decision 942 and informs 943 the CU 310 of the AC decision made by it.

DU1 320 coordinates 952 with DU2 320 to effect the handover. DU1 320 sends a message 953 to the UE 352 telling it of the handover and that the UE 352 should thereafter connect to DU2 320.

In response, the UE 352 sends a path connection request 960 to DU2 320. DU2 320 acknowledges the connection to the UE 352 by sending 961 a message to the CU 310.

The CU 310 established 981 a DRB that it forwards to DU2 320, who in turn forwards 982 it to the UE 352.

The CU 310 then acknowledges the connection 990 by sending a message to the CN 330/AMF.

In some examples, when the DU 320 receives a connection request from the UE 352 over the Uu interface 325, the processing performed by the DU 320 may depend upon the AC methodology employed.

In a first example scenario, the centralized AC methodology is being employed, in which the CU 310 makes all the AC decisions. In this scenario, the DU 320 simply forwards the connection request to the CU 310 for handling. In some cases, the DU 320 also exposes its capabilities to the CU 310 at the same time that it forwards the connection request. In some cases, the DU 320 has been configured to expose its capabilities to the CU 310 on a periodic (or other) basis. Regardless, the CU 310 has sufficient information to make the AC decision and it does so.

In a second example scenario, the handshake AC methodology is being employed, in which the CU 310 and the DU 320 make their own AC decisions. In this scenario, upon receipt of the connection request, the DU 320 makes its own AC decision.

If the DU 320 is able to support admission of the UE 352, it forwards the connection request to the CU 310 for the CU 310 to make its own AC decision, together with an indication that the DU 320 can support admission of the UE 352.

If the DU 320 will not support admission of the UE 352, it forwards the connection request to the CU 310 for the CU 310 to make its own AC decision, together with an indication that the DU 320 will not support admission of the UE 352. In some cases, the DU 320 additionally forwards the connection request to another DU 320 (if any) associated with the CU 310 and advises the CU 310 that it has done so. Such other DU 320 makes its own AC decision and communicates an indication reflecting its decision to the CU 310. Presumably, provided there remain other DUs 320 associated with the CU 310, the second DU 320 may forward the connection to a third (and so on) DU 320 in the event that it will not support admission of the UE 352 until there no longer remain other DUs 320 associated with the CU 310, or else one of the DUs decides to support admission of the UE 352.

In this second scenario, the DU 320 does not expose any of its capabilities to the CU 310 as it is unnecessary to do so.

### Method Actions

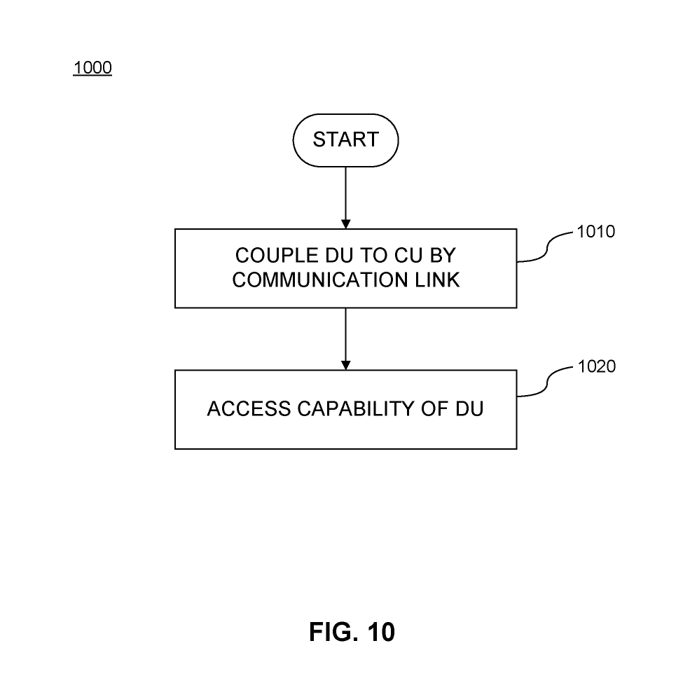

Turning now to FIG. 10, there is shown a flow chart, shown generally at 1000, showing example actions taken in a method for configuring a network entity such as the gNB 300 comprising at least one CU 310 and at least one DU 320 at the at least one CU 310.

One example action 1010 is to couple a DU 320 to the CU 320 by a communication link 315.

One example action 1020 is to access at least one capability of the DU 32.

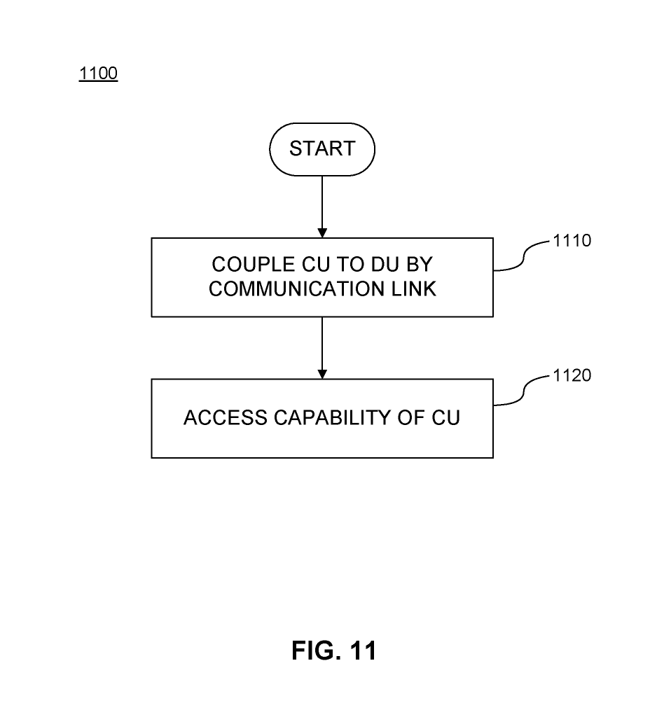

Turning now to FIG. 11, there is shown a flow chart, shown generally at 1100, showing example actions take in a method for configuring a network entity such as the gNB 300 comprising at least one CU 310 and at least one DU 320 at the at least one DU 320.

One example action 1110 is to couple a CU 310 to the DU 320 by a communication link.

One example action 1120 is to access at least one capability of the CU 110.

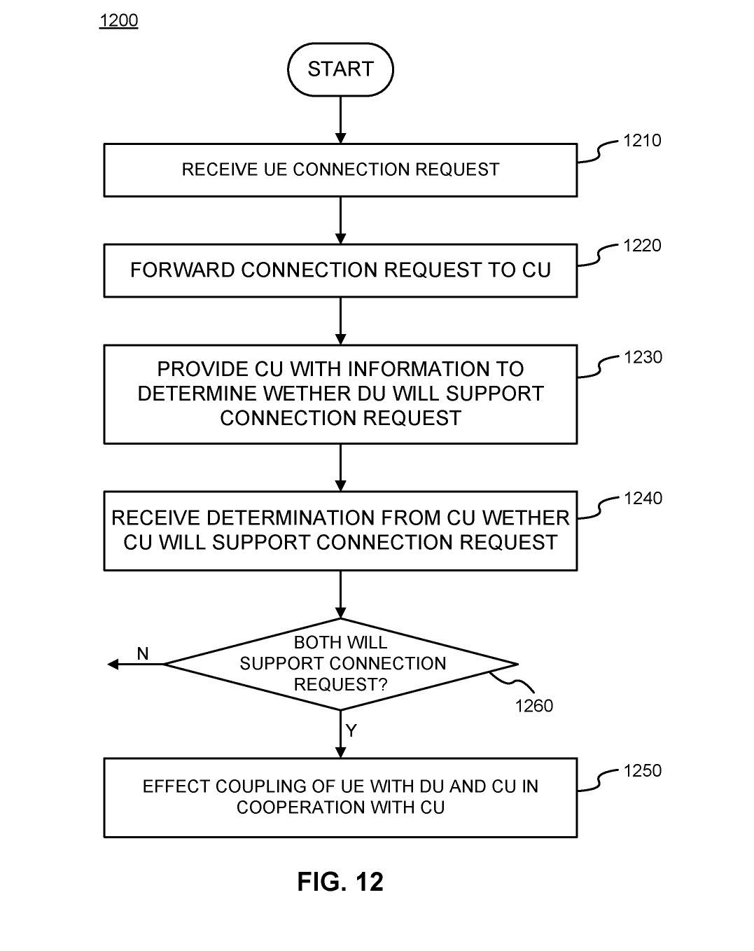

Turning now to FIG. 12, there is shown a flow chart, shown generally at 1200, showing example actions taken by a DU 320 in a method for configuring a radio transceiver such as the gNB 300 comprising at least one CU 310 and at least one DU 320.

One example action 1210 is to receive a connection request from a UE 352.

One example action 1220 is to forward the connection request to the CU 310.

One example action 1230 is to provide the CU 310 with information that permits it to determine whether the DU 320 will support the connection request.

One example action 1240 is to receive a determination from the CU 310 whether the CU will support the connection request.

One example action 1250 is to effect coupling of the UE 352 with the DU 320 and CU 310 in cooperation with the CU 310 if both support the connection request 1860.

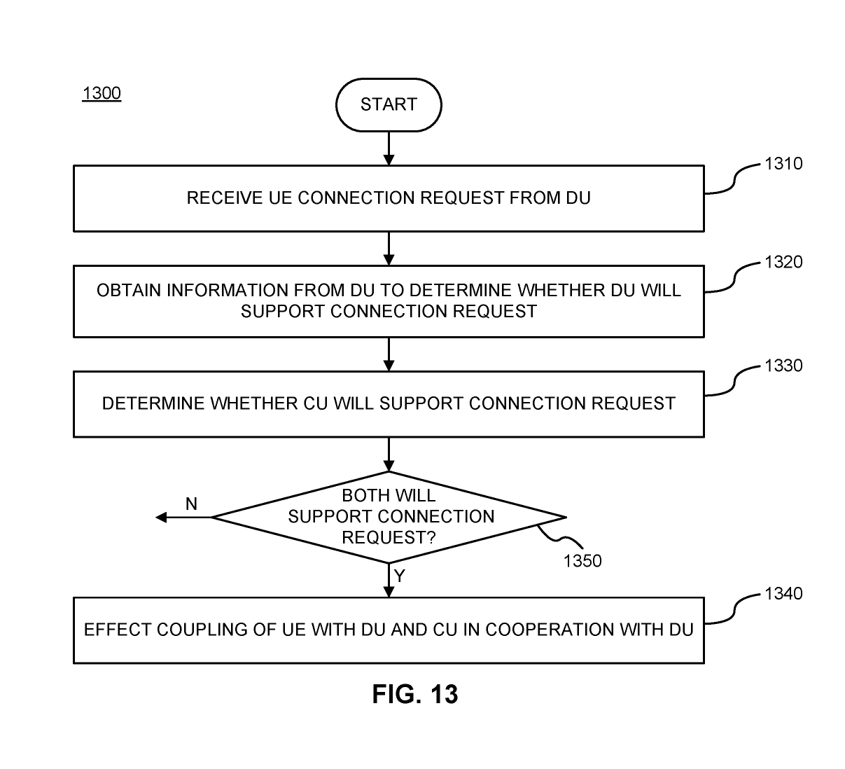

Turning now to FIG. 13, there is shown a flow chart, shown generally at 1300, showing example actions taken by a CU 310 in a method for configuring a network entity such as the gNB 300 comprising at least one CU 310 and at least one DU 320.

One example action 1310 is to receive a connection request of a UE 352 from the DU 320 after it has received it from the UE 352.

One example action 1320 is to obtain information from the DU 320 that permits the CU 310 to determine whether the DU 320 will support the connection request.

One example action 1330 is to determine whether the CU 310 will support the connection request and communicate it to the DU 320.

One example action 1340 is to effect coupling of the UE 352 with the DU 320 and CU 310 in cooperation with the DU 320 if both support the connection request 1950.

Having described in detail examples that are in accordance with the present disclosure, it is noted that the examples reside primarily in combinations of apparatus or devices and processing actions related to interactions between one or more of such components.

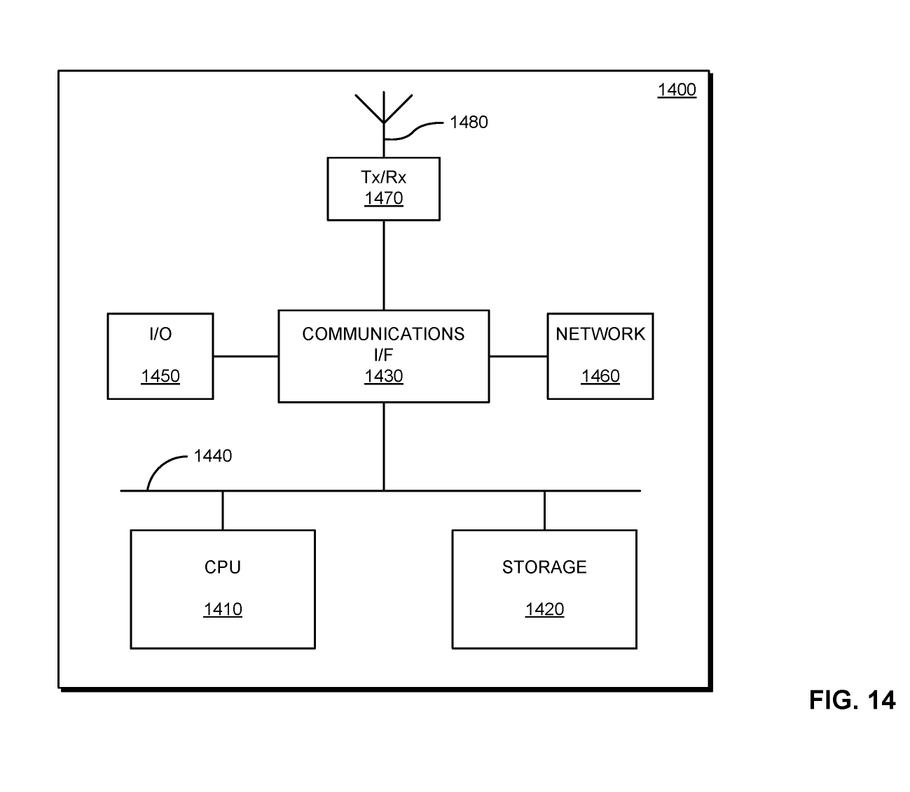

FIG. 14 is a block diagram of a processing system that may be used for implementing one or more devices or functions performed thereon, shown generally at 900, such as the CU 310 or the DU 320 or the UE 352 or components thereof, for performing actions in one or more of the methods disclosed herein.

The device 1400 comprises a processing unit 1410, a storage medium 1420 and a communications interface 1430. In some examples, the device 1400 may also comprise a processing bus 1440 interconnecting some or all of these components, as well as other devices or controllers. In some examples, the device 1400 may comprise an input/output (I/O) device 1450, a network connectivity device 1460, a transceiver 1470 or an antenna 1480.

The processing unit 1410 controls the general operation of the device 1400, by way of non-limiting example, by sending data or control signals to the communications interface 1430, and by retrieving data or instructions from the storage medium 1420 to execute method actions disclosed herein.

However configured, the hardware of the processing unit 1410 is configured so as to be capable of operating with sufficient software, processing power, memory resources and network throughput capability to handle any workload placed upon it.

The storage medium 1420 provides storage of data used by the device 1400, as described above. The storage medium 1420 may also be configured to store computer codes or code sequences, instructions, configuration information, data or scripts in a computer program residing on or in a computer program product that, when executed by the processing unit 1410, causes the processing unit 1410 to perform one or more functions associated with the device 1400, as disclosed herein.

The communications interface 1430 facilitates communication with the I/O device(s) 1450, network connectivity device(s) 1460 or other entities in a communications network. In some examples, the communications interface 1430 is for connection to a transceiver 1470, which may comprise one or more transmitters or receivers, and at least one antenna 1480, through which such communications are effected. As such, the communications interface 1430 may comprise one or more interfaces and a suitable number of ports, to couple internal and external I/O devices 1450, network connectivity devices 1460 and the like to the processing unit 1410.

Network connectivity devices 1460 may enable the processing unit 1410 to communicate with the internet or one or more intranets (not shown) to communicate with remote devices, for data processing or communications. The network connectivity devices 1460 may also comprise or interface with one or more transceivers 1470 for wirelessly or otherwise transmitting and receiving signals. With such a network connection, it is contemplated that the processing unit 1410 may receive information from the network or might output information to the network in the course of performing one or more of the above-described method actions.

The transceiver 1470 operates to prepare data to be transmitted or to convert received data for processing by the processing unit 1410.

Other components, as well as related functionality of the device 1400, may have been omitted in order not to obscure the concepts presented herein.

According to an aspect, there is disclosed a method for configuring a network entity comprising at least one CU and at least one DU in a wireless communication system comprising actions, at the at least one CU, of coupling a DU to the at least one CU by a communication link, and accessing at least one capability of the DU.

In an embodiment, the action of accessing can include receiving at least one report of the at least one capability from the DU. In an embodiment, the at least one report can describe all capabilities of the DU or capability changes since a previously received report.

In an embodiment, the at least one capability can be accessed along the communication link. In an embodiment, the communication link can be an F1 interface link or an F1-AP interface link.

In an embodiment, the at least one capability can be accessed upon a triggering event. In an embodiment, the triggering event can be the coupling of the DU to the at least one CU. In an embodiment, the triggering event can be triggered by the DU and can be a UE arrival, departure or mobility event, a signal strength change above a threshold value, a RRC inactive, active or idle mode change, a MICO change or a UE status change. In an embodiment, the triggering event can be triggered by the CU and can be establishment of a new PDU session or a CN user plane traffic path switch.

In an embodiment, the at least one capability can be accessed at a pre-determined time. In an embodiment, the pre-determined time can be a periodic interval.

In an embodiment, the at least one capability can be a bandwidth, a frequency, a technical capability, a modulation scheme, a MIMO antenna configuration, a carrier aggregation capability, a QoS capability, a maximum rate, a latency capability, a supported QCI type, an URLLC service type, an MTC service type, an eMBB service type, a RAT type, a number of simultaneous UE connections supported, an indoor, outdoor, macro, small, pico, home nodeB or other cell type, a coverage type, an available power, an antenna height, coverage information, a beamforming capability, a sectorization capability, an omni capability, a SON capability, an FFR capability, an ICIC capability, a resource allocation configurability, a scheduling capability, a hard or soft slicing capability, a neighbouring cell, a number of remaining QoS type session or a percentage of loading.

In an embodiment, the method can include accessing at least one capability from another CU. In an embodiment, the other CU can be a gNB different from that of the at least one CU and the gNBs can be coupled by an Xn interface link.

In an embodiment, the method can include exposing at least one capability of the at least one CU to an entity coupled thereto by a communication link. In an embodiment, the entity can be a DU, another CU or a CN.

In an embodiment, the at least one capability exposed by the at least one CU can include capabilities of another entity coupled thereto and accessed by the at least one CU therefrom. In an embodiment, the network entity can be a gNB comprising the at least one CU.

According to a further aspect, which can be combined with other aspects, there is disclosed a method of configuring a network entity comprising at least one CU and at least one DU in a wireless communication system comprising actions, at the at least one DU, of coupling a CU to the at least one DU by a communication link, and accessing at least one capability of the CU.

In an embodiment, the action of accessing can include receiving at least one report of the at least one capability from the CU. In an embodiment, the at least one report can describe all capabilities of the CU or capability changes since a previously received report.

In an embodiment, the at least one capability can be accessed along the communication link. In an embodiment, the communication link can be an F1 interface link or an F1-AP interface link.

In an embodiment, the at least one capability can be accessed upon a triggering event. In an embodiment, the triggering event can be the coupling of the CU to the at least one DU. In an embodiment, the triggering event can be triggered by the DU and can be a UE arrival, departure or mobility event, a signal strength change above a threshold value, a RRC inactive, active or idle mode change, a MICO change or a UE status change. In an embodiment, the triggering event can be triggered by the CU and can be establishment of a new PDU session or a CN user plane traffic path switch.

In an embodiment, the at least one capability can be accessed at a pre-determined time. In an embodiment, the pre-determined time can be a periodic interval.

In an embodiment, the at least one capability can be a traffic processing capability, a number of active sessions, a maximum rate, a latency, a QoS treatment capability, a dynamic loading status, a percentage of maximum allocated resources, a number of additional sessions that can be supported, an amount of remaining resources, an amount of used resources, a max round trip time for PDCP function, a max round trip time for AM, a link latency, an OTA latency, an optimization capability, a performance capability, a number of multiple legs, DC, a handover capability, a load balance capability, an interference management capability, a SON optimization capability, a mobility capability, a mobility location, a connectivity type, a neighbouring cell, a network connectivity or a DU connectivity.

In an embodiment, the method can include accessing at least one capability from another DU. In an embodiment, the other DU can be a gNB different from that of the at least one DU and the gNBs can be coupled by an Xn interface link.

In an embodiment, the method can include exposing at least one capability of the at least one DU to an entity coupled thereto by a communication link. In an embodiment, the entity can be a CU, another DU or a CN.

In an embodiment, the at least one capability exposed by the at least one DU can include capabilities of another entity coupled thereto and accessed by the at least one DU therefrom. In an embodiment, the network entity can be a gNB comprising the at least one DU.

According to a further aspect which can be combined with previous aspects, there is disclosed a CU having a processor and a non-transitory memory containing instructions that, when executed by the processor, causes the CU to couple a DU to the CU by a communication link, and access at least one capability of the DU.

According to a further aspect which can be combined with previous aspects, there is disclosed a DU having a processor and a non-transitory memory containing instructions that, when executed by the processor, causes the DU to couple a CU to the CU by a communication link, and access at least one capability of the CU.

According to a further aspect which can be combined with previous aspects, there is disclosed a method in a gNB including a plurality of units comprising at least one Central Unit (CU) and at least one Distributed Unit (DU). The method comprises: a first unit receiving capability information indicative of a capability of at least one other unit; and the first unit performing Admission Control at least partially based on the received capability information.

### Terminology

The terms “including” and “comprising” are used in an open-ended fashion, and thus should be interpreted to mean “including, but not limited to”. The terms “example” and “exemplary” are used simply to identify instances for illustrative purposes and should not be interpreted as limiting the scope of the invention to the stated instances. In particular, the term “exemplary” should not be interpreted to denote or confer any laudatory, beneficial or other quality to the expression with which it is used, whether in terms of design, performance or otherwise.

The terms “couple” and “communicate” in any form are intended to mean either a direct connection or indirect connection through some interface, device, intermediate component or connection, whether electrically, mechanically, chemically, or otherwise.

References in the singular form include the plural and vice versa, unless otherwise noted.

As used herein, relational terms, such as “first” and “second”, and numbering devices such as “a”, “b” and the like, may be used solely to distinguish one entity or element from another entity or element, without necessarily requiring or implying any physical or logical relationship or order between such entities or elements.

### General

All statements herein reciting principles, aspects and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated that the present disclosure, which is described by the claims and not by the implementation details provided, which can be modified by omitting, adding or replacing elements with equivalent functional elements, provides many applicable inventive concepts that may be embodied in a wide variety of specific contexts. The specific embodiments discussed are merely illustrative of specific ways to make and use the disclosure, and do not limit the scope of the present disclosure. Rather, the general principles set forth herein are considered to be merely illustrative of the scope of the present disclosure.

Although the present invention has been described with reference to specific features and embodiments thereof, it is evident and apparent that various modifications, combinations and variations covering alternatives, modifications and equivalents will be apparent to persons having ordinary skill in the relevant art upon reference to this description and may be made to the embodiments disclosed herein, without departing from the present disclosure, as defined by the appended claims. Accordingly the specification, drawings and the embodiments disclosed therein are to be considered as an illustration of the invention as defined by the appended claims, and are to be contemplated to cover any and all modifications, variations, combinations or equivalents that fall within the scope of the present invention and as examples only, with a true scope of the disclosure being disclosed by the following numbered claims:

What is claimed is:

1. A method for configuring a radio transceiver comprising at least one central unit (CU) and at least one distributed unit (DU) coupled thereto in a wireless communication system comprising actions, at the at least one DU, of:
receiving a connection request from a user equipment (UE);
forwarding the connection request to the at least one CU;
providing the at least one CU with information that permits the at least one CU to determine whether the at least one DU will support the connection request;
receiving a determination from the at least one CU as to whether the at least one CU will support the connection request; and
if the at least one CU and the at least one DU will support the connection request, effecting coupling of the UE with the at least one DU and the at least one CU in cooperation with the at least one CU.

2. The method according to claim 1, wherein the action of providing comprises coordinating with a management plane (MP) entity to identify resources accessible by the at least one DU to support the connection request.

3. The method according to claim 1, wherein the action of providing comprises actions of making a DU decision as to whether the at least one DU will support the connection request and communicating the DU decision to the at least one CU.

4. The method according to claim 3, wherein the action of providing comprises, if the DU decision is not to support the communication request, transmitting the connection request to a further one of the at least one DUs to make a DU decision for communication to the at least one CU and advising the at least one CU that the connection request has been forwarded to the further one of the at least one DUs.

5. The method according to claim 1, wherein the action of providing comprises actions of exposing capabilities of the at least one DU to the at least one CU to allow the at least one CU to make a decision as to whether the at least one DU will support the connection request, and communicating the decision to the at least one DU.

6. The method according to claim 5, wherein the action of exposing occurs in advance of the action of receiving the connection request.

7. The method according to claim 6, wherein the action of exposing occurs periodically.

8. The method according to claim 1, wherein the action of receiving comprises the at least one CU coordinating with a management plane (MP) entity to identify resources accessible by the at least one CU to support the connection request.

9. The method according to claim 1, wherein the action of effecting coupling comprises informing the at least one CU to arrange for traffic intended for the UE to be routed through the at least one DU.

10. A method for configuring a radio transceiver comprising at least one central unit (CU) and at least one distributed unit (DU) coupled thereto in a wireless communication system comprising actions, at the at least one CU, of:
receiving a connection request of a user equipment (UE) from the at least one DU after the at least one DU has received it from the UE;
obtaining information from the at least one DU that permits the at least one CU to determine whether the at least one DU will support the connection request;
arriving at a CU determination whether the at least one CU will support the connection request and communicating the CU determination to the at least one DU; and
if the at least one CU and the at least one DU will support the connection request, effecting coupling of the UE with the at least one DU and the at least one CU in cooperation with the at least one DU.

11. The method according to claim 10, wherein the action of obtaining comprises the at least one DU coordinating with a management plane (MP) entity to identify resources accessible by the at least one DU to support the connection request.

12. The method according to claim 10, wherein the action of obtaining comprises learning a DU decision from the at least one DU as to whether the at least one DU will support the connection request.

13. The method according to claim 12, wherein the action of obtaining comprises, if the DU decision is not to support the communication request, receiving advice that the at least one DU has communicated the connection request to a further one of the at least one DUs.

14. The method according to claim 10, wherein the action of obtaining comprises actions of receiving capabilities of the at least one DU exposed by the at least one DU to allow the at least one CU to make a DU determination as to whether the at least one DU will support the connection request, and communicating the DU determination to the at least one DU.

15. The method according to claim 14, wherein the action of receiving capabilities occurs in advance of the action of receiving the connection request.

16. The method according to claim 15, wherein the action of receiving capabilities occurs periodically.

17. The method according to claim 10, wherein the action of arriving comprises coordinating with a management plane (MP) entity to identify resources accessible by the at least one CU to support the connection request.

18. The method according to claim 10, wherein the action of effecting coupling comprises arranging for traffic intended for the UE to be routed through the at least one DU.

19. A distributed unit (DU) coupled to at least one central unit (CU) in a radio transceiver of a wireless communication system, having a processor and a non-transitory memory containing instructions that, when executed by the processor, causes the DU to perform actions of:
receiving a connection request from a user equipment (UE);
forwarding the connection request to the at least one CU;
providing the at least one CU with information that permits the at least one CU to determine whether the DU will support the connection request;
receiving a determination from the at least one CU as to whether the at least one CU will support the connection request; and
if the at least one CU and the DU will support the connection request, effecting coupling of the UE with the DU and the at least one CU in cooperation with the at least one CU.

20. A central unit (CU) coupled to at least one distributed unit (DU) in a radio transceiver of a wireless communication system, having a processor and a non-transitory memory containing instructions that, when executed by the processor, causes the CU to perform actions of:
receiving a connection request of a user equipment (UE) from the at least one DU after the at least one DU has received it from the UE;
obtaining information from the at least one DU that permits the CU to determine whether the at least one DU will support the connection request;
arriving at a CU determination whether the CU will support the connection request and communicating the CU determination to the at least one DU; and
if the CU and the at least one DU will support the connection request, effecting coupling of the UE with the at least one DU and the CU in cooperation with the at least one DU.
